(19) United States
(12) Patent Application Publication
(10) Pub. No.: US 2010/0034211 A1
(43) Pub. Date: Feb. 11, 2010

(54) Network system, information processor, connection destination introducing apparatus, information processing method, recording medium storing program for information processor, and recording medium storing program for connection destination introducing apparatus

(75) Inventor: Yasushi Yanagihara, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/149,661

(22) Filed: May 6, 2008

(30) Foreign Application Priority Data
Jul. 9, 2007 (JP) 2007-180067

(51) Int. Cl. H04L 12/56

(52) U.S. Cl. 370/408

(57) ABSTRACT

A distribution system is provided, which is capable of distributing content more stably as compared with the case where connection is newly changed after distribution of content is stopped.

In a distribution system in which a plurality of nodes are connected in a hierarchical tree shape and content is distributed to any of the nodes, a content distribution state is detected, and a quality parameter (which is controlled by a connection destination introducing server) indicative of a criterion to determine whether the state deteriorates or not is stored in a node.

When distribution is continued, and the state of the distribution becomes worse than the criterion, an upstream node introduction request message is transmitted to a connection destination introducing server and, according to a reply to the message, connection is changed.

### CROSS REFERENCE TO RELATED APPLICATIONS

The present application claims priority from Japanese Patent Application NO. 2007-180067, which was filed on Jul. 9, 2007, the disclosure of which is herein incorporated by reference in its entirety.

### BACKGROUND OF THE INVENTION

1. Technical Field

The present invention belongs to a technical fields of a network system, an information processor, a connection destination introducing apparatus, an information processing method, a recording medium storing a program for an information processor, and a recording medium storing a program for a connection destination introducing apparatus. More specifically, the invention belongs to a technical field of a network system for distributing information such as moving pictures and music distributed from a distributor while stepwisely relaying the information by information processors connected so as to construct a plurality of hierarchical levels on the downstream of the distributor.

2. Discussion of Related Art

In recent years, the speed of the Internet line for household is conspicuously increasing. With the increase in the speed, a content distribution system is being commonly used. In the content distribution system, a network is constructed by connecting a plurality of personal computers and the like in houses in a hierarchical tree shape having, at its apex, one distribution server as a distributor. Via the network, the distribution information is distributed from the distribution server. The distribution information such as movies and music will be also called “content” hereinbelow. The content distribution system will be also simply called a “distribution system” hereinbelow.

The network will be called “topology” from the viewpoint of the connection mode. In the topology of such a network, each of the personal computers constructing the network is generally called a “node”. Further, for example, Japanese Patent Application Laid-Open No. 2006-033514 (FIGS. 9 and 10) (patent document 1) discloses a conventional technique of the distribution system.

In the invention disclosed in the patent document 1, in the case where a relaying function in a node belonging to an upper level in the hierarchical tree structure and relaying content stops due to, for example, turn-off of the power, a new topology including a node other than the node whose relaying function stops is automatically reconstructed using the distribution server as an apex.

The reconstruction is executed only between nodes related to a node in which a failure occurs in the distribution system but the connection state in the other nodes in the distribution system is considered.

### SUMMARY OF THE INVENTION

In the configuration of the invention disclosed in the patent document 1, a process for reconstructing the topology is started after the relaying function in any of the nodes completely stops. That is, only after distribution to a node on the downstream side in the hierarchical tree completely stops, the process for the reconstruction is started for the node whose relaying function stops.

In the content distribution, there is a case such that a distribution amount gradually decreases for some reason before the distribution completely stops. In such a case, in the invention disclosed in the patent document 1, since the process for reconstructing the topology starts only after the distribution completely stops, when the distribution amount becomes a certain amount, there is the case that the reproducing process in a node to which content is distributed stops. It causes a problem such that, after the distribution amount decreases and completely stops, distribution of content to a node on the downstream side is stopped until reconstruction of the topology is completed.

The present invention has been achieved in view of the problems, and it is an object of the present invention to provide a distribution system realizing more stable distribution as compared with the case where a new connection is established only after content distribution stops completely.

In order to solve the above problem, the invention according to claim 1 relates to an information processor included in a network system in which a plurality of information processors are connected in a hierarchical tree shape via a network, and distribution information is distributed to any of the information processors along the hierarchical tree, comprising:

distribution state detecting means for detecting a state of distribution of the distribution information;

storing means for storing reference information indicative of a criterion to determine whether the state deteriorates or not;

request information transmitting means, when the distribution is continued and the state becomes worse than the criterion, for transmitting request information that requests for transmission of connection destination information indicative of a new information processor to be connected in the network system, to a connection destination introducing apparatus included in the network system and transmitting the connection destination information; and

reconnecting means for establishing a new connection for the distribution to another information processor indicated by the connection destination information transmitted from the connection destination introducing apparatus in response to the transmitted request information.

### BRIEF DESCRIPTION OF THE DRAWINGS

FIG. 1 is a block diagram showing a schematic configuration of a distribution system of an embodiment.

FIG. 2 is a block diagram showing a detailed configuration of the distribution system of the embodiment.

FIGS. 3A and 3B are diagrams showing a withdrawing process in the distribution system of the embodiment. FIG. 3A is a diagram showing a withdrawing process in a time-out method, and FIG. 3B is a diagram showing a withdrawing process in an event notifying method.

FIG. 4 is a diagram showing a reconnecting process in the embodiment.

FIG. 5 is a diagram (I) showing a quality parameter setting process in the embodiment.

FIG. 6 is a diagram (II) showing the quality parameter setting process in the embodiment.

FIG. 7 is a diagram (III) showing the quality parameter setting process in the embodiment.

FIG. 8 is a diagram (IV) showing the quality parameter setting process in the embodiment.

FIG. 9 is a block diagram showing a schematic configuration of a broadcasting station in the embodiment.

FIG. 10 is a block diagram showing a schematic configuration of a node in the embodiment.

FIG. 11 is a block diagram showing a schematic configuration of a connection destination introducing server in the embodiment.

FIG. 12 is a flowchart (I) showing processes in the node in the embodiment.

FIG. 13 is a flowchart (II) showing processes in the node in the embodiment.

FIG. 14 is a flowchart (III) showing processes in the node in the embodiment.

FIG. 15 is a flowchart showing processes in the broadcasting station in the embodiment.

FIG. 16 is a flowchart (I) showing processes in the connection destination introducing server in the embodiment.

FIG. 17 is flowchart (II) showing processes in the connection destination introducing server in the embodiment.

### DETAILED DESCRIPTION OF PREFERRED EMBODIMENTS OF THE INVENTION

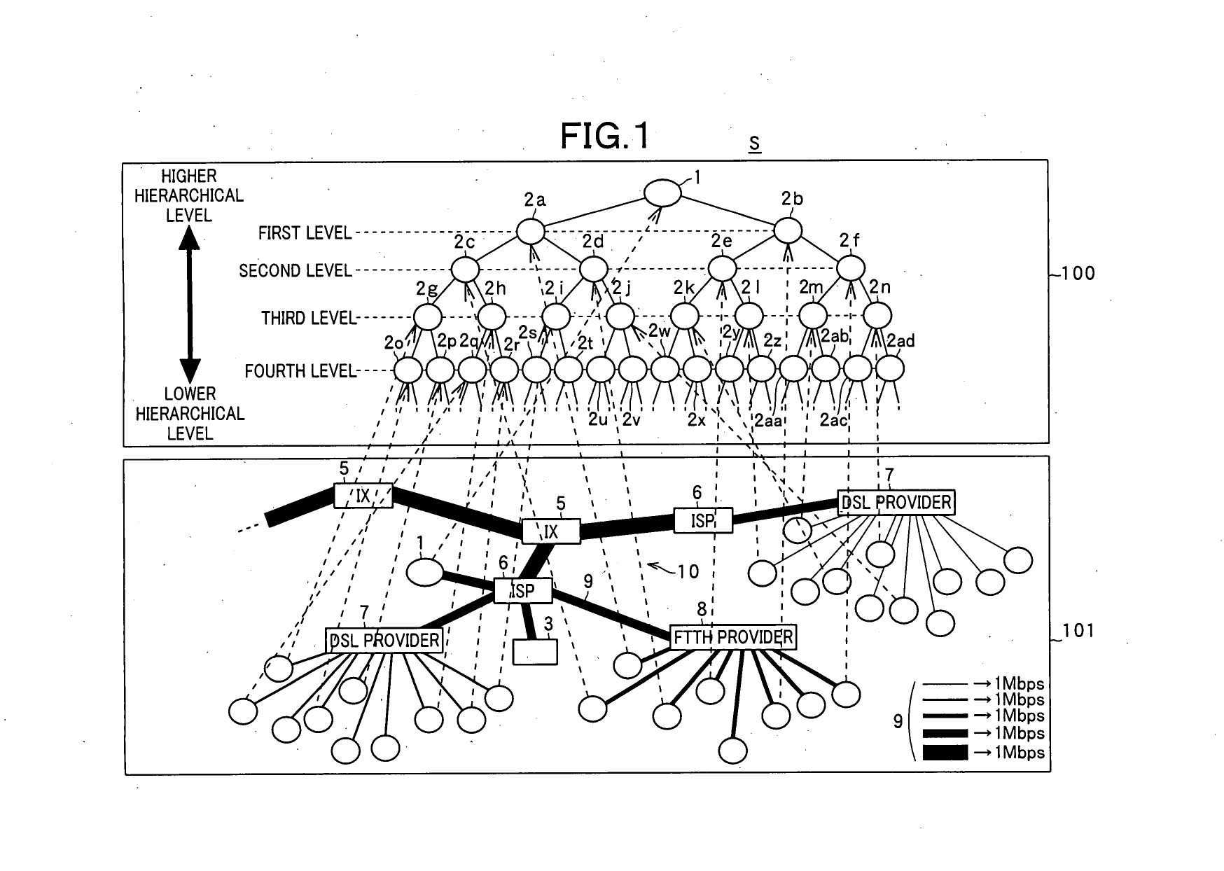

Best modes for carrying out the present invention will now be described with reference to FIGS. 1 to 8. The following embodiments relate to the cases of applying the present invention to a so-called hierarchical-tree-type distribution system.

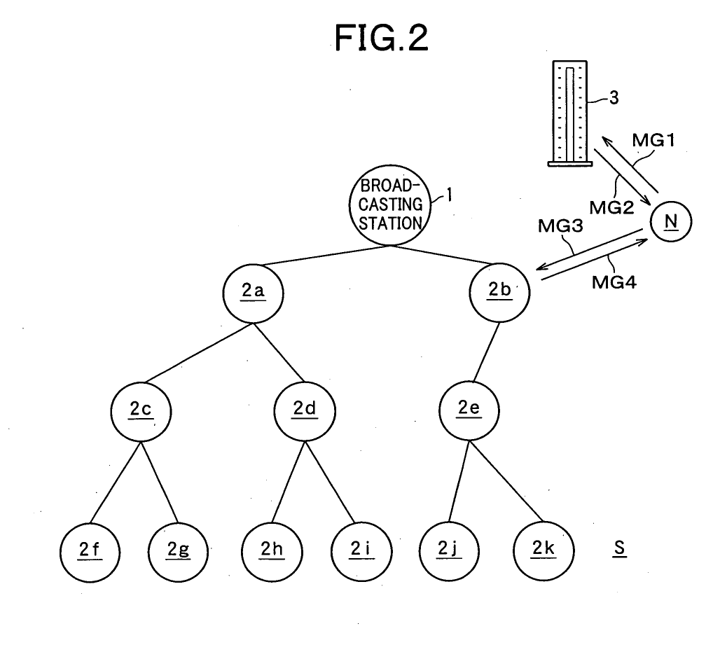

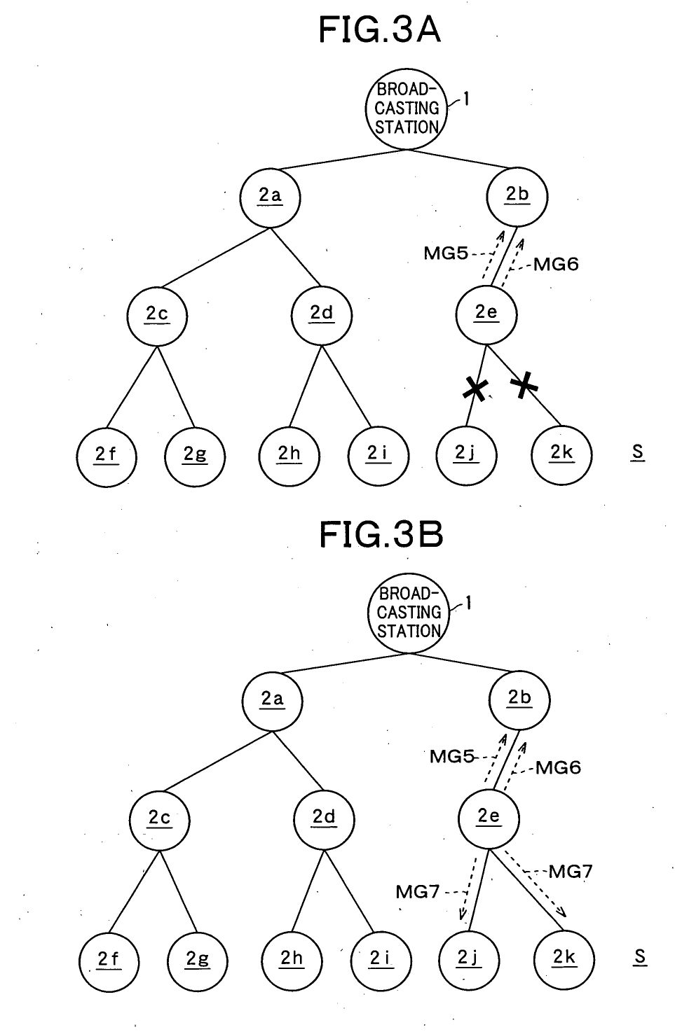

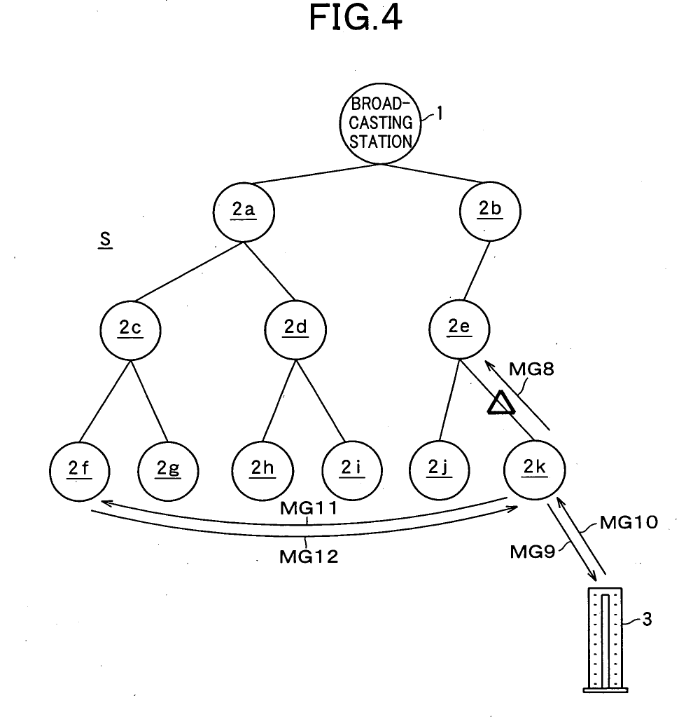

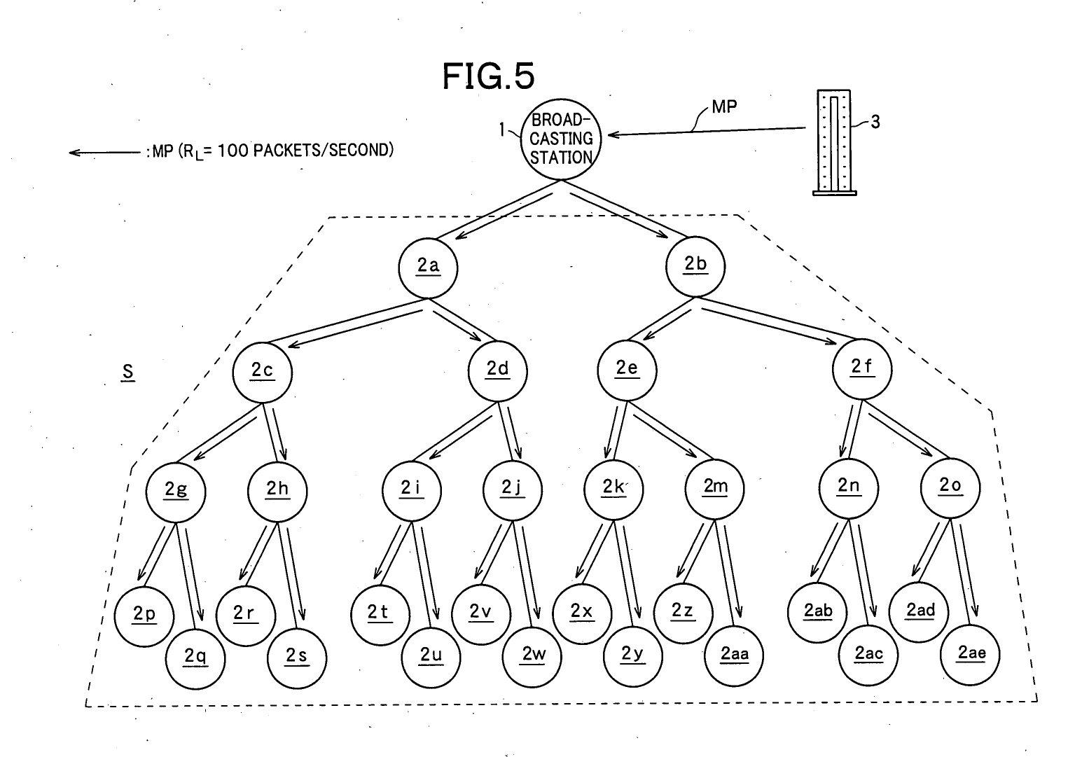

FIG. 1 is a diagram showing a connection mode of each of devices constructing a distribution system of an embodiment. FIG. 2 is a block diagram showing processes performed in the case where a node newly participates in the distribution system. Further, FIGS. 3A and 3B are diagrams showing processes performed in the case where a node withdraws from the distribution system. FIG. 4 is a diagram showing a node reconnecting process in the distribution system. FIGS. 5 to 8 are diagrams each showing the reconnecting process in the embodiment.

### (I) General Configuration of Distribution System

First, a schematic configuration and function of the distribution system of the embodiment will be described with reference to FIG. 1.

As shown in FIG. 1, a distribution system S of the embodiment is constructed by using a network (network in the real world) such as the Internet. Concretely, for example, as shown in a lower frame 101 in FIG. 1, a network 10 of the real world includes IXs (Internet exchanges) 5, ISPs (Internet Service Providers) 6, DSL (Digital Subscriber Line) providers (apparatuses) 7, FTTH (Fiber To The Home) providers (apparatuses) 8, routers (not shown), and communication lines (for example, telephone lines, optical cables, and the like) 9. In the lower frame 101 in FIG. 1, thicknesses of solid lines corresponding to the communication lines 9 express widths of bands (for example, data transfer speeds) of the communication lines 9.

The distribution system S of the first embodiment includes a broadcasting station 1 as a distributer of (continuous) packets each corresponding to a distribution unit of content to be distributed and a plurality of nodes 2a, 2b, 2c, 2d, . . . . Based on the network 10 shown in the lower frame 101 in FIG. 1, the distribution system S is constructed as shown in an upper frame 100 in FIG. 1. More concretely, in the distribution system S, the broadcasting station 1 is used as the apex (the top), and the plurality of nodes 2 are connected in a tree shape via communication paths while forming a plurality of levels (four levels in an example of FIG. 1). In the configuration, at the time of distributing content, the plural continuous packets are distributed while being relayed by the nodes 2 from upstream (upper level) to downstream (lower level). In the following description, in the case of referring to any of the nodes 2a, 2b, 2c, 2d, . . . , it will be simply called a node 2 for convenience.

The broadcasting station 1 is actually realized as a broadcasting station apparatus including a recorder made by a hard disk drive or the like for storing content data corresponding to the above-described content to be broadcasted, a controller for controlling distribution of the content, and an interface for controlling input/output of content data or the like to/from the network 10. In practice, the node 2 is realized as a node of a personal computer, a so-called set-top box, or the like which is mounted in a house and can be connected to the Internet.

In FIG. 1, the nodes 2 shown in the upper frame 100 participate in the distribution system S. To participate in the distribution system S, as will be described later, a node which is not participating has to send a participation request message to a connection destination introducing server 3 (in the lower frame 101 in FIG. 1) and has to be authorized for participation by the connection destination introducing server 3.

By using a not-shown database, the connection destination introducing server 3 manages location information (for example, an IP (Internet Protocol) address and a port number (such as standby port number) of the broadcasting station 1 and each of the nodes 2 participating in the distribution system S) and topology information indicting topologies (connection modes) between the broadcasting station 1 and the nodes 2 and between the nodes 2 in the distribution system S. The connection destination introducing server 3 authorizes a participation request from a not-participating node and notifies the node of the location information of the participating node 2 as a connection destination (in other words, the participating node 2 selected in consideration of the hierarchical-tree-shaped topology). Consequently, the node to which the location information is notified (which is to participate in the distribution system S) establishes a connection to the participating node 2 on the basis of the location information to thereby participate in the distribution system S.

The hierarchical-tree-shaped topology in the distribution system S is determined in consideration of the maximum number, balance (symmetry), and the like of nodes 2 on the downstream side directly connected to each of the nodes 2. It may be determined in consideration of the above and, in addition, for example, the locality between the nodes 2 (which is equal to proximity on the network 10 and generally it describes the small number of routing hops as high locality.

In the case such that the power supply of the participating node 2 is turned off or the communication state with respect to the node 2 becomes bad, the node 2 withdraws from the distribution system S. Consequently, the nodes 2 and the like on the downstream side directly connected to the withdrawn node 2 have to obtain the location information of the other participating nodes 2 as new connection destinations from the connection destination introducing server 3 and establish a connection. In the following description, a change of connection to the new connection destination will be properly called “reconnection”.

Further, the hierarchical-tree-shaped topology is formed every broadcasting station 1, in other words, every broadcast channel. That is, in the upper frame 100 in FIG. 1, only one broadcast channel is shown (there is also a case that a single broadcasting station 1 performs broadcasting in a plurality of broadcast channels). For example, when a broadcast channel is switched by the user of a participating node 2, the node 2 obtains the location information of another participating node 2 after the switched broadcast channel from the connection destination introducing server 3 and establishes a connection.

### (II) Configuration of Distribution System in Embodiment and Process of Participation in the Distribution System

Next, the configuration of the topology in the distribution system S in the embodiment and processes performed to newly participate in the distribution system S will be described more concretely with reference to FIG. 2.

For example, in the case where a new node N shown in FIG. 2 newly participates in the distribution system S, the node N sends an upstream node introduction request message MG1 related to the participation request to the connection destination introducing server 3. When the participation is authorized by the connection destination introducing server 3 and an upstream node candidate message MG2 including the information of participation authorization and location information of the participating node 2 on the immediately upstream side (the node 2b in FIG. 2) is sent, the newly participating node N sends a connection request message MG3 to the participating node 2 (the node 2b in FIG. 2) indicated by the location information. In response to the message, a connection permission response message MG4 is obtained from the node 2 (2b), the node N is connected immediately downstream of the node 2 (2b), and it completes the process of making the node N participate in the distribution system S.

After a node 2 newly joins in the distribution system S, content data corresponding to content distributed from the broadcasting station 1 is relayed from the upstream side to the downstream side in the hierarchy in the distribution system S, thereby distributing the content to the nodes 2.

(III) Process of Withdrawal from Distribution System in Embodiment

Next, a process of withdrawal from the distribution system S in the embodiment will be described with reference to FIGS. 3A and 3B. FIGS. 3A and 3B show the case where the node 2e withdraws from the distribution system S for a reason such that the power switch is turned off. In the following, two kinds of withdrawing processes on the nodes 2i and 2k connected immediately downstream of the withdrawing node 2e will be described with reference to FIGS. 3A and 3B.

In the withdrawing process, as shown in FIGS. 3A and 3B, the withdrawing node 2e sends a data transmission stop request message MG5 and a connection cancellation request message MG6 to an upstream node (the node 2b in FIGS. 3A and 3B) as the supplier of content to the node 2e.

The node 2b which received the two request messages stops the content relaying process which has been executed, thereby stopping distribution of content to the node 2e withdrawing. After that, by erasing the information related to the node 2e from the node management information in the node 2b concurrently with the content distribution stopping process, the node 2b disconnects the connection to the node 2e. As a result, distribution of content to the withdrawing node 2e from the node 2b is stopped. In the case where other nodes (in FIGS. 3A and 3B, the nodes 2j and 2k) exist on the immediately downstream side of the withdrawing node 2e, a process of restoring a path of distributing content to the nodes 2 on the downstream side is performed by using any of the following two methods.

As a first example of the restoring process, each of the nodes 2 (including the nodes 2j and 2k) constructing the distribution system S always monitors the distribution state of content from the node 2 connected on the immediately upstream side. Using deterioration in the content distribution state (indicated by “X” mark in FIG. 3A) as a trigger, it is regarded that the node 2 (2e) on the immediately upstream side withdraws, connection to the node 2 (2e) is interrupted, and a process of re-connection to a new node 2 on the upstream side starts (refer to FIG. 2).

A second example of the restoring process relates to a so-called event notifying method. In the event notifying method, each of the nodes 2 participating in the distribution system S does not execute a monitoring process such as the time-out method shown in FIG. 3A. On withdrawal from the topology as the distribution system S, the node 2e transmits the data transmission stop request message MG5 and the connection cancellation request message MG6, and transmits a withdrawal report message MG7 indicating that the node 2e itself withdraws to the nodes 2j and 2k connected immediately downstream. On receipt of the withdrawal report message MG7 from the node 2e on the immediately upstream side, the nodes 2j and 2k interrupt the connection to the node 2e and starts the process of reconnection to another upstream node 2 (refer to FIG. 2).

By the process described above, also after withdrawal of the node 2e in the distribution system S, distribution of content to the nodes 2j and 2k which were on the immediately downstream side of the node 2e is continued.

### (IV) Reconnecting Process of Embodiment

The reconnecting process of the embodiment will be described more concretely with reference to FIG. 4. The reconnecting process of the embodiment is different from the above-described reconnecting process accompanying withdrawal of the node 2 on the upstream side (refer to FIG. 3) (in the case where the amount of distribution from the node 2 becomes zero in short time). The reconnecting process of the embodiment is performed to address the case where, for example, the amount of distribution from a node 2 on the upstream side decreases step by step due to a failure or the like (indicated by the triangle sign in FIG. 4) which occurs on a network between the node 2 and the upstream node 2 and becomes zero.

More concretely, in the distribution system S of the embodiment illustrated in FIG. 4, each of nodes 2 always monitors a distribution state of content from a node 2 connected immediately upstream. It is assumed that a failure or the like (indicated by the triangle sign in FIG. 4) occurs between the nodes 2e and 2k shown in FIG. 4. In this case, the node 2k can recognize that the amount of distribution to the node 2k itself gradually decreases due to the failure or the like. When the distribution amount becomes below a distribution amount shown by a quality parameter of the embodiment pre-stored in the node 2k, the node 2k sends a message MG8 of request for separation from the node 2e to the node 2e. In addition, the node 2k sends an upstream node introduction request message MG9 of a request for introduction of another node 2 as a new connection destination related to the reconnection to the connection destination introducing server 3.

There are two modes with respect to the relation between the distribution status and the quality parameter corresponding to the timing when the node 2k sends the separation request message MG8 and the upstream node introduction request message MG9.

In the first mode, the quality parameter indicates the lower limit value of a packet rate which is preset for each of the nodes 2. When the packet rate as the distribution amount to the node 2k (from the node 2e) becomes lower than the lower limit value, the separation request message MG8 and the like is transmitted.

In the second mode, the quality parameter indicates the upper limit value of a packet loss ratio which is preset for each of the nodes 2. When the loss ratio of packets in the content distributed to the node 2k (from the node 2e) exceeds the upper limit value, the separation request message MS8 and the like is transmitted.

The connection destination introducing server 3 which has received the upstream node introduction request message MG9 in any of the two modes transmits an upstream node candidate message MG10 including the location of a participating node 2 (the node 2f in the case of FIG. 4) as a new intermediately upstream node 2 to the node 2k. The node 2k can therefore obtain the information on the participating node 2 (the node 2f in the case of FIG. 4). The node 2k sends a connection request message MG11 to the node 2f and obtains a connection permission response message MG12 from the node 2 (2f) as a response message. As a result, the node 2k is reconnected on the immediately downstream side of the node 2 (2f) and distribution of content is newly started or restarted.

Each of the nodes 2 periodically notifies the connection destination introduction server 3 of an average value of the packet rate or packet loss ratio of content transmitted from the node 2 connected on the upstream side (reception quality statistical information which will be described later).

On the other hand, based on the reception quality statistical information, the connection destination introduction server 3 which has received the reception quality statistical information re-determines new quality parameters to a node 2 which is likely to be reconnected among the other nodes 2 connected on the downstream side of the node 2 or quality parameters to a node 2 to which the node 2 to be reconnected is expected to be reconnected in near future, and distributes the quality parameters to the related node 2 via the broadcasting station 1. That is, the connection destination introduction server 3 constantly monitors the distribution state in the topology and, before the node 2 is reconnected due to a failure such as degradation in the quality of a stream, performs a process of updating the quality parameters of each of the nodes 2.

### (V) Quality Parameter Updating Process of Embodiment

A quality parameter updating process of the embodiment will now be described with reference to FIGS. 5 to 8.

### (A) Process of Setting Quality Parameter in Stationary State

First, in the case where no failure or the like occurs in the network 10 constructing the distribution system S (that is, in the case where distribution in the stationary state is performed), as shown in FIG. 5, the connection destination introduction server 3 distributes a quality parameter MP having a preset default value to each of the nodes 2 via the broadcasting station 1.

In the quality parameter MP, information indicative of the value itself of the quality parameter MP and the node ID of the node 2 to which the quality parameter MP is sent is written. Further, the quality parameters MP in all of nodes 2 belonging to the distribution system S surrounded by a broken line in FIG. 5 are the same. As a concrete example of the default value, it is preferable to set a default value corresponding to the bit rate of content itself to be distributed. That is, in the case of distributing content of, for example, a bit rate of 2 mega bps (bit per second), when the quality parameter MP is used as a lower limit value R_{L} of the packet rate as the default value of the quality parameter MP to be distributed to each of the nodes 2 in advance, the lower limit value R_{L} is set to about 100 packets/second as shown in FIG. 5. In the case of using the quality parameter as the upper limit value of the packet loss ratio, it is preferable to set the upper limit value to about 8 packets/second.

(B) Process of Setting Quality Parameter in the Case where the Number of Failures or the like Occurred is Small

In contrast, in the case where the failure or the like occurs in one place or so in the distribution system S, immediately after the occurrence of the failure or the like, a quality parameter MP1 having a new value is distributed to each of the nodes 2 so as to lower the sensitivity of only the quality parameter MP in each of the nodes 2 connected below the location where the failure or the like occurs. Also in the quality parameter MP1, information indicative of the value itself of the quality parameter MP1 and the node ID of the node 2 as the destination of the quality parameter MP1 is written.

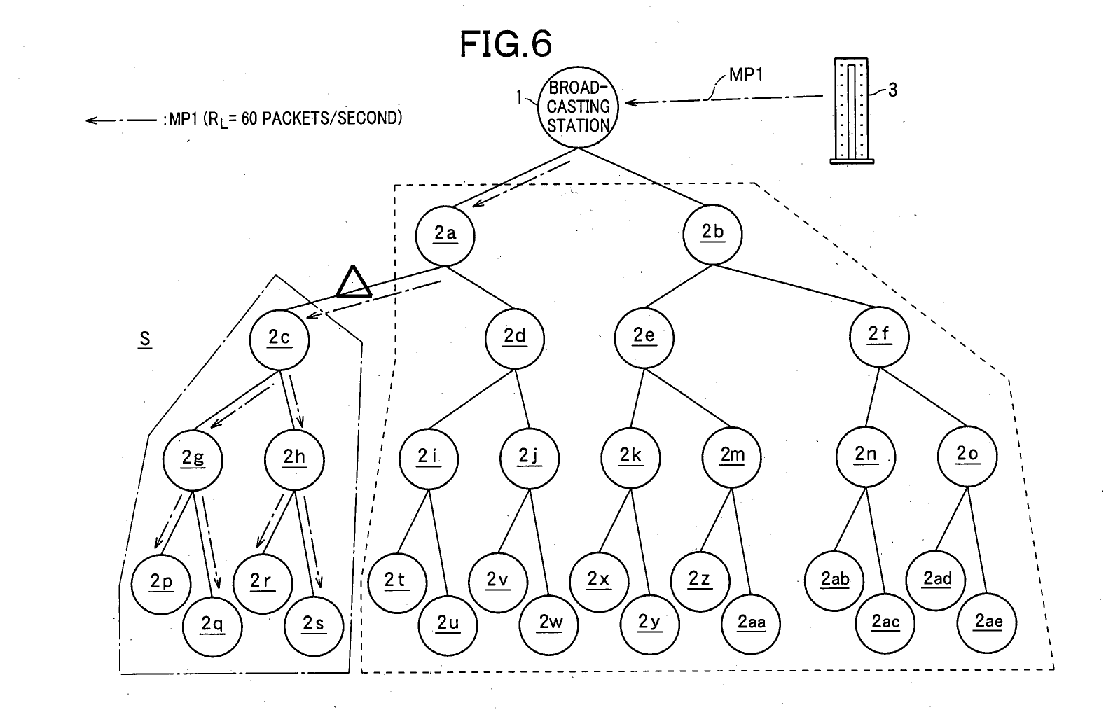

More concretely, in the case where a failure or the like occurs in the position of a triangle mark shown in FIG. 6 (between the nodes 2a and 2c), before the node 2c which has sensed the failure performs reconnection, the connection destination introduction server 3 generates the quality parameter MP1 having lowered sensitivity and for the nodes 2 (2g, 2h, 2p, 2q, 2r, and 2s) below the node 2c expected to be reconnected with reference to reception quality statistics periodically reported from the node 2, and distributes the quality parameter MP1 via the broadcasting station 1.

As a concrete example of the new quality parameter MP1, in the case of using the quality parameter MP1 as the lower limit value R_{L} of the packet rate in order to lower the sensitivity as compared with that in the stationary state (refer to FIG. 5), it is preferable to set the lower limit value R_{L}=about 60 packets/second as shown in FIG. 6. In the case of using the quality parameter as the upper limit value of the packet loss ratio, it is preferable to set the upper limit value to about 16 packets/second.

As described above, by setting the quality parameter MP in the node 2 connected on the downstream side of the location where the failure or the like occurs to the new quality parameter MP1 having the lowered sensitivity, the reconnecting process is prevented from being performed in short time in each of the nodes 2.

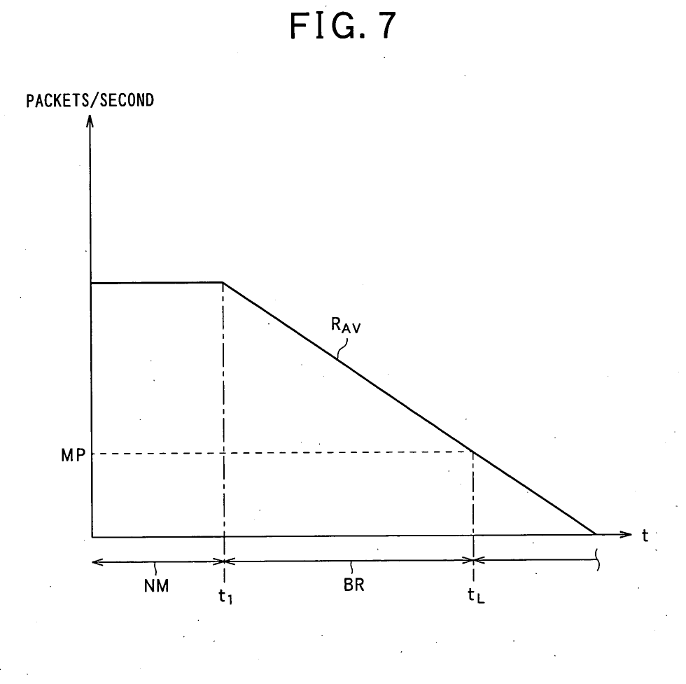

In the period in which the reconnecting process shown in FIG. 6 is executed (see reference characters BR in FIG. 7), no content is distributed to the node 2 itself performing the reconnecting process and also to a part surrounded by alternate long and short dash lines shown in FIG. 6. In this case, in the part surrounded by the alternate long and short dash lines, an average packet rate RAV in a past predetermined period gradually decreases with time from the value in a period NM in the stationary state as shown in FIG. 7. It means that even when the reconnecting process is executed in a certain node 2, the reconnecting process is not executed in the other nodes 2 connected on the downstream side of the certain node 2 until a timing (see reference characters t_{L} in FIG. 7) at which the average packet rate RAV becomes lower than the value of the quality parameter MP.

By executing the process of setting the quality parameter MP described with reference to FIGS. 6 and 7, the reconnection in the nodes 2 on the downstream side of the location where the failure or the like occurs can be prevented from being executed in short time, and the stability of the entire distribution system S improves.

(C) Process of Setting Quality Parameter in the Case Where the Number of Failures or the like Occurred is Large

On the other hand, also in the case where the failure or the like occurs in two or more places in the distribution system S, immediately after the occurrence of the failure or the like, the sensitivity of the quality parameter MP in each of the nodes 2 connected below the location where the failure or the like occurs is lowered as in the case of FIG. 6. In addition, in the case where the failure or the like occurs in the two or more places, a process of lowering the sensitivity of the quality parameter MP is performed also for each of the nodes 2 connected to locations where the failure or the like does not occur.

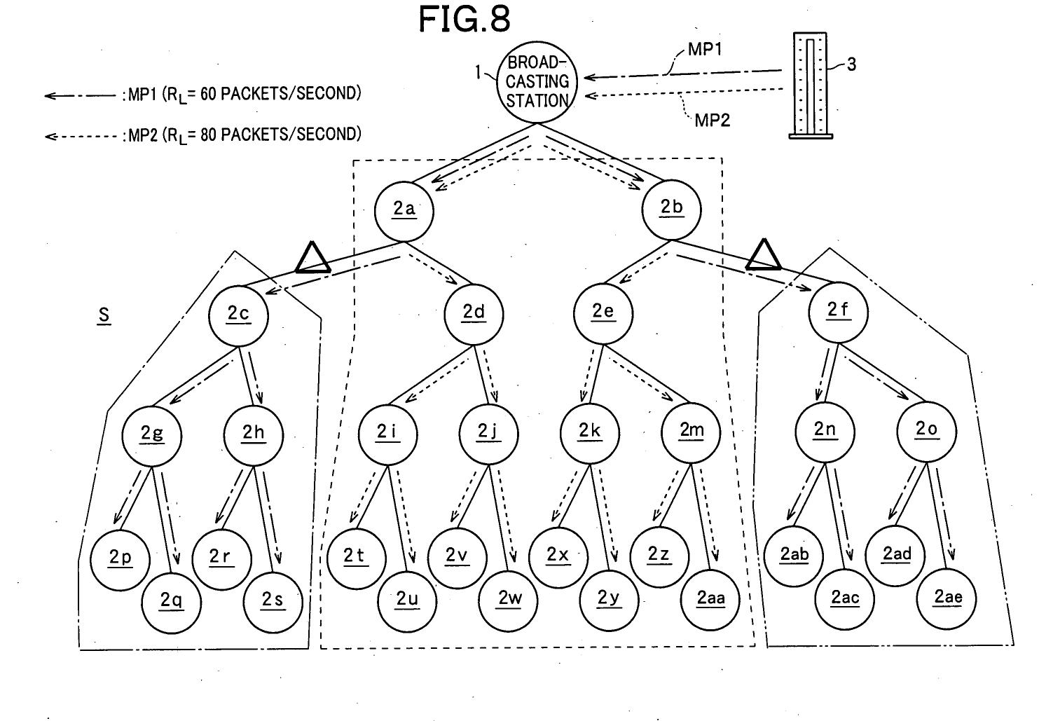

More concretely, in the case where a failure or the like occurs in the locations of two triangle marks shown in FIG. 8 (between the nodes 2a and 2c and between the nodes 2b and 2f), the quality parameter MP1 having sensitivity in a manner similar to that in the case of FIG. 6 is distributed from the connection destination introducing server 3 via the broadcasting station 1 to the nodes 2 on the downstream side of the locations where the failure or the like occurs (in the case of FIG. 8, nodes 2g, 2h, 2p, 2q, 2r, 2s, 2n, 2o, 2ab, 2ac, 2ad, and 2ae in the part surrounded by the alternate long and short dash line and the part surrounded by alternate long and two short dashes line). In addition, a quality parameter MP2 having sensitivity higher than that of the other nodes 2 (the node 2c and the like) but is lower than that in the stationary state is distributed from the connection destination introducing server 3 via the broadcasting station 1 to the other nodes 2 connected in locations having no relation with the failure or the like in a hierarchical tree structure (in the case of FIG. 8, nodes 2a, 2b, 2d, 2e, 2i, 2j, 2k, 2m, 2t, 2u, 2v, 2w, 2x, 2y, 2z, and 2aa in the part surrounded by the broken line). Also in the case of the quality parameter MP2, information indicative of the value itself of the quality parameter MP2 and the node ID of the node 2 as a destination of the quality parameter MP2 is written.

As concrete values of the new quality parameters MP1 and MP2, as the quality parameter MP1, a value similar to that of the case shown in FIG. 6 is preferable. On the other hand, in the case of using the quality parameter MP2 as the lower limit value R_{L} of the packet rate in order to lower the sensitivity as compared with that in the stationary state (refer to FIG. 5), it is preferable to set the lower limit value R_{L}=about 80 packets/second as shown in FIG. 8. In the case of using the quality parameter as the upper limit value of the packet loss ratio, it is preferable to set the upper limit value to about 12 packets/second.

As described above, by setting the quality parameter MP in the node 2 connected on the downstream side of the location where the failure or the like occurs to the new quality parameter MP1 having the lowered sensitivity in a manner similar to the case of FIG. 6, the reconnecting process is prevented from being performed in short time in each of the nodes 2.

In addition, for the nodes 2 which are not related to the failure or the like, the quality parameter MP is set to be higher than that in the case of FIG. 6 and lower than that in the stationary state. Consequently, by temporarily suppressing the reconnecting process in the nodes 2 which are not related to the failure or the like, a node 2 already executing the reconnecting process (a node 2 connected on the downstream side of the location where the failure or the like occurs) can be easily reconnected to a node 2 which is not related to the failure or the like.

By executing the setting process using the two quality parameters MP described with reference to FIG. 8, in addition to the effects of the case described with reference to FIGS. 6 and 7, chain-reaction of the reconnection in the entire distribution system S is prevented, so that the stability of the entire distribution system S improves.

### Embodiment

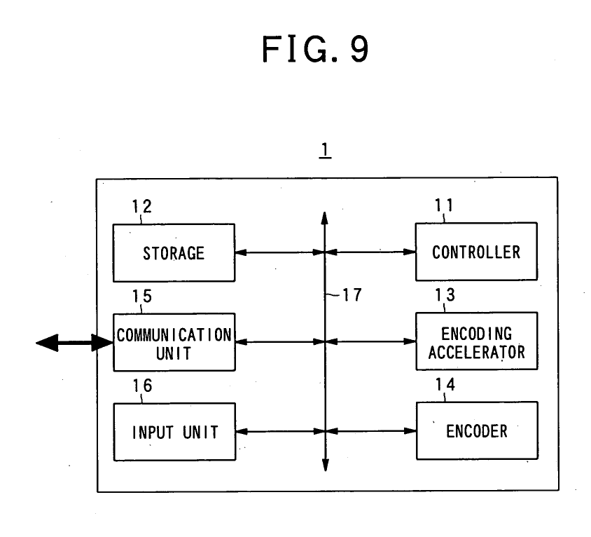

Next, concrete configurations and processes of the broadcasting station 1, the nodes 2, and the connection destination introducing server 3 belonging to the distribution system S of the embodiment will be described as an embodiment with reference to FIGS. 9 to 17.

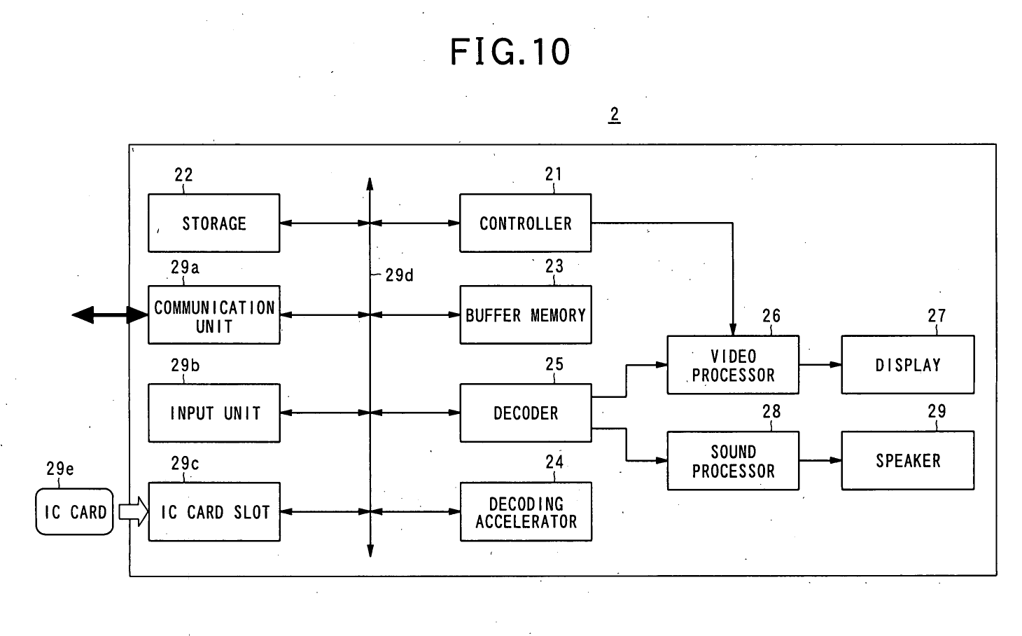

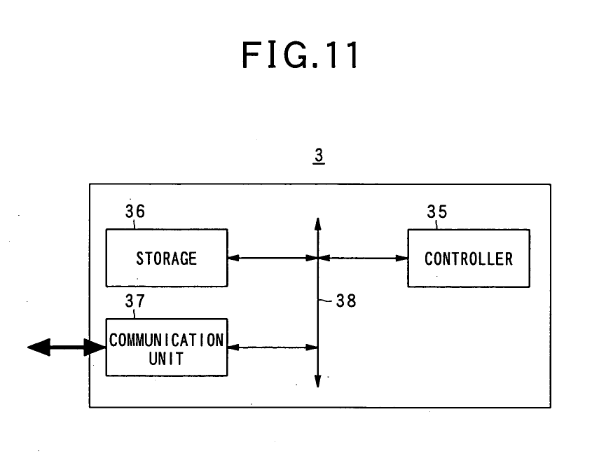

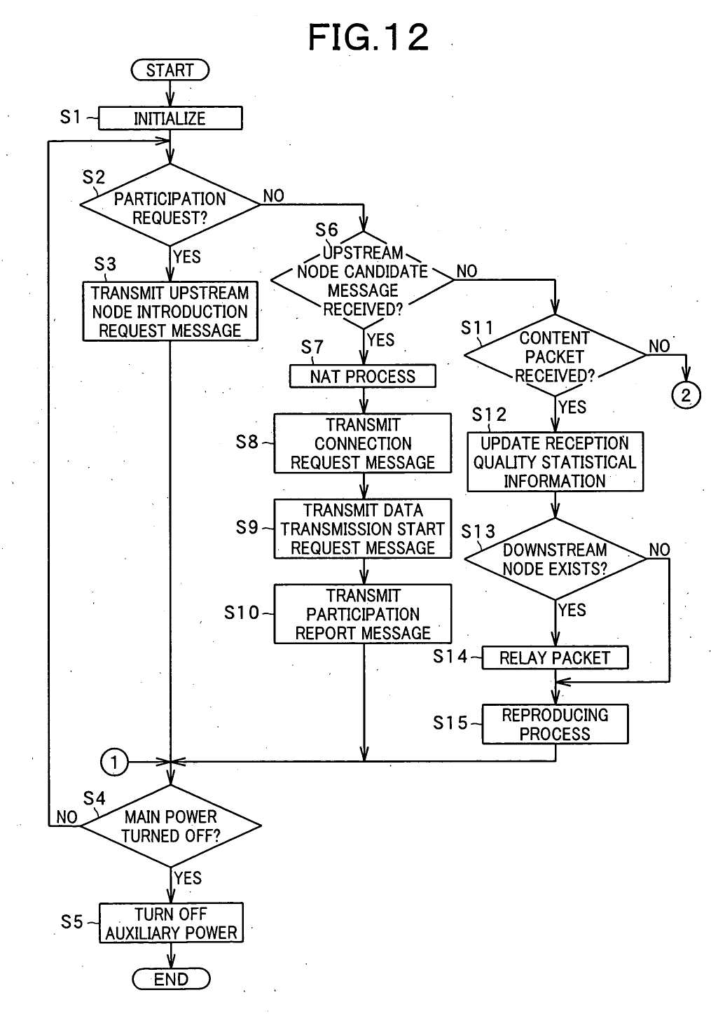

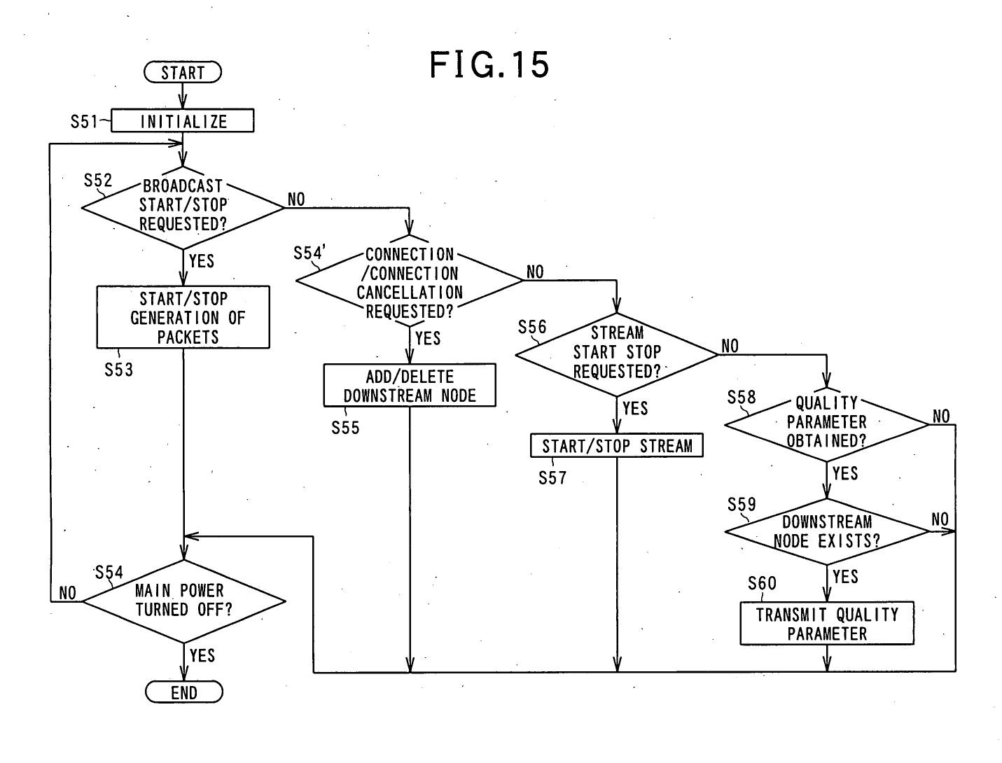

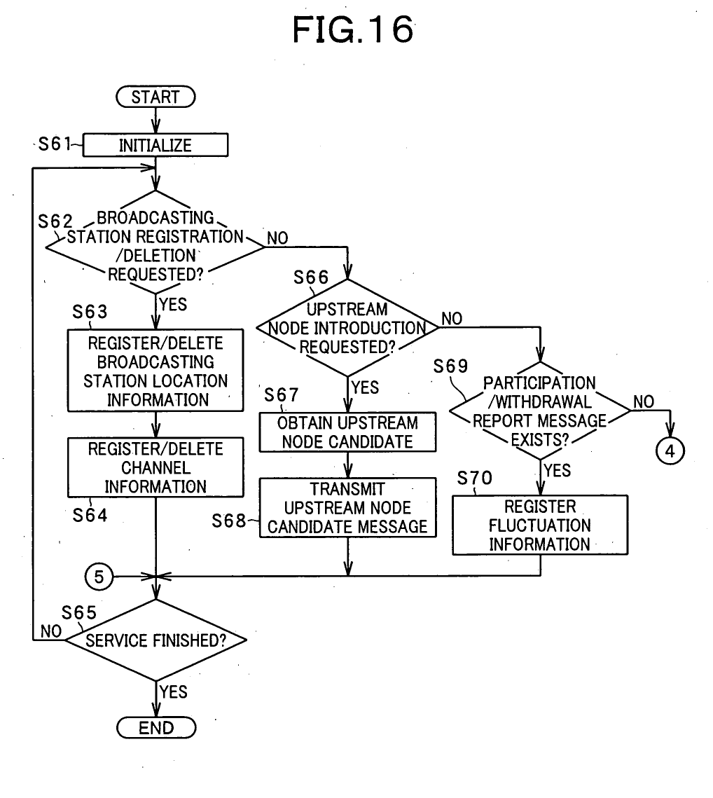

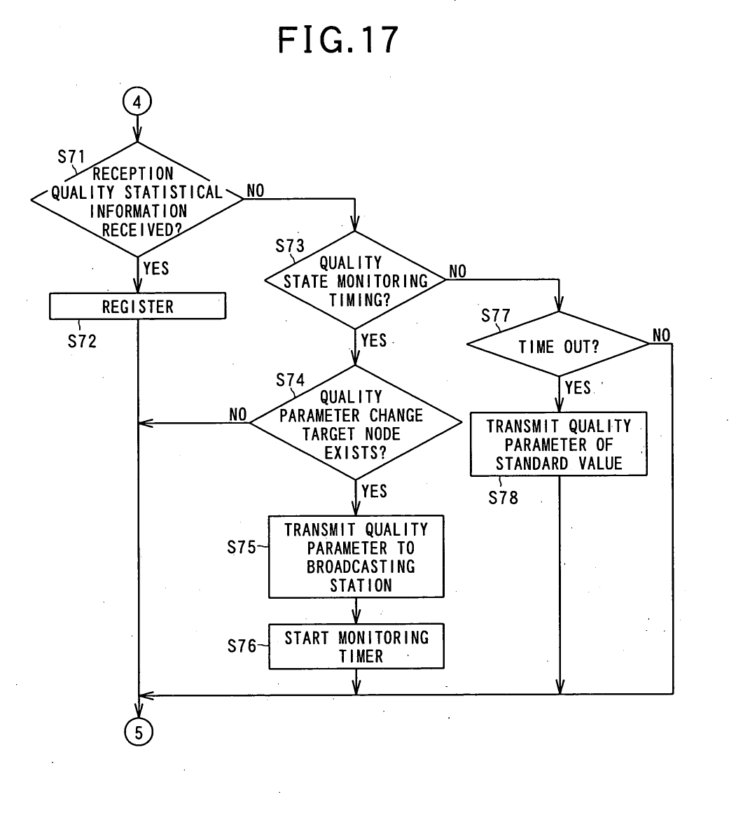

FIG. 9 is a block diagram showing a detailed configuration of the broadcasting station 1 of the embodiment. FIG. 10 is a block diagram showing a detailed configuration of a representative node 2 in the embodiment. FIG. 11 is a block diagram showing a detailed configuration of the connection destination introducing server 3 of the embodiment. FIGS. 12 to 14 are flowcharts commonly showing processes in the embodiment executed in the representative node 2. FIG. 15 is a flowchart showing processes in the embodiment executed in the broadcasting station 1. FIGS. 16 and 17 are flowcharts showing processes in the embodiment executed in the connection destination introducing server 3.

First, schematic configuration and schematic operation of the broadcasting station 1 of the embodiment will be described with reference to FIG. 9.

As shown in FIG. 9, the broadcasting station 1 includes a controller 11, a storage 12, an encoding accelerator 13, an encoder 14, a communication unit 15, and an input unit 16. The components are connected to each other via a bus 17.

The controller 11 is constructed by a CPU having a computing function, a work RAM, a ROM for storing various data and programs (including an OS and various applications), and the like. The storage 12 is made by an HDD or the like for storing the content data (packets). The encoding accelerator 13 is used for encoding content data with a cipher key.

The encoder 14 converts the content data into a specified data format. The communication unit 15 controls communication of information with the node 2 or the like via a communication line or the like. The input unit 16 is, for example, a keyboard, a mouse, and the like, receives an instruction from the user (operator), and gives an instruction signal according to the instruction to the controller 11.

In the configuration, the controller 11 controls the whole broadcasting station 1 by making the CPU execute a program stored in the storage 12 or the like, and executes processes of the embodiment which will be described later. In addition, the controller 11 converts the data format of the content data stored in the storage 12 by using the encoder 14, makes the encoding accelerator 13 encode the content data with a cipher key, divides the content data by predetermined data amounts to generate the plural continuous packets, and distributes a stream of the packets to the nodes 2 (nodes 2a and 2b in the embodiments shown in FIGS. 1 to 6 and FIG. 8) via the communication unit 15.

The controller 11 determines the distribution destination of the content data with reference to a connection mode (topology) table stored in the storage 12. In the connection mode table, at least the IP address and the port number of a node 2 to be connected to the broadcasting station 1 (in other words, a node 2 to which content data is to be distributed) are written.

Next, schematic configuration and schematic operation of each of the nodes 2 in the embodiment will be described with reference to FIG. 10. The nodes 2 of the embodiment basically have the same configuration.

As shown in FIG. 10, the node 2 in the embodiment has a controller 21 as distribution state detecting means, reconnecting means, and updating means, a storage 22 as storing means, a buffer memory 23, a decoding accelerator 24, a decoder 25, a video processor 26, a display 27, a sound processor 28, a speaker 29, a communication unit 29a as request information transmitting means, an input unit 29b, and an IC card slot 29c. The controller 21, storage 22, buffer memory 23, decoding accelerator 24, decoder 25, communication unit 29a, input unit 29b, and IC card slot 29c are connected to each other via a bus 29d.

The controller 11 is constructed by a CPU having a computing function, a work RAM, a ROM for storing various data and programs (including an OS and various applications), and the like. The storage 22 is made by an HDD or the like for storing various data, a program, and the like and stores the quality parameter MP (or MP1 or MP2) distributed from the connection destination introducing server 3 via the broadcasting station 1 in a nonvolatile storage area. The buffer memory 23 temporarily accumulates (stores) received content data.

The decoding accelerator 24 decodes encoded content data accumulated in the buffer memory 23 with a decipher key. The decoder 25 decodes (compresses) video data, audio data, and the like included in the decoded content data and reproduces the data. The video processor 26 performs a predetermined drawing process on the reproduced video data and the like and outputs the processed data as a video signal.

The display 27 is a CRT, a liquid crystal display, or the like and displays a video image on the basis of the video signal output from the video processor 26. The sound processor 28 D/A (digital-to-analog) converts the reproduced audio data to an analog sound signal, amplifies the signal by an amplifier, and outputs the amplified signal. The speaker 29 outputs, as sound waves, the sound signal output from the sound processor 28.

The communication unit 29a controls a communication between the broadcasting station 1 and another node 2 or the like via a communication line or the like. The input unit 29b is, for example, a mouse, a keyboard, an operation panel, a remote controller, or the like and outputs an instruction signal according to each of various instructions from the user (viewer) to the controller 21. The IC card slot 29c is used for reading/writing information from/to an IC card 29e.

The IC card 29e has tampering resistance and, for example, is given to the user of each of the nodes 2 from the administrator or the like of the distribution system S. In this case, the tampering resistance is obtained by taking a measure against tampering so that secret data can be prevented from being read and easily analyzed by unauthorized means. The IC card 29e is constructed by an IC card controller made by a CPU, a nonvolatile memory having the tampering resistance such as an EEPROM, and the like. In the nonvolatile memory, the user ID, a decoding key for decoding encoded content data, a digital certificate, and the like are stored. When a node 2 participates in a distribution system S, the digital certificate is transmitted together with the upstream node introduction request message MG1 (including the location information of the node 2) to the connection destination introducing server 3.

On the other hand, the buffer memory 23 is, for example, an FIFO (First In First Out) type ring buffer memory. Under control of the controller 21, content data received via the communication unit 29a is temporarily stored into a storage area indicated by a reception pointer.

The controller 21 controls the node 2 generally by making the CPU included in the controller 21 read and execute a program stored in the storage 22 or the like, and executes processes in the embodiment which will be described later. In addition, as routine processes, the controller 21 receives a plurality of packets distributed from the upstream via the communication unit 29a, writes the packets into the buffer memory 23, reads packets (packets received in the past for predetermined time) stored in the buffer memory 23, and transmits (relays) the packets to the node 2 on the downstream side via the communication unit 29a. On the other hand, the buffer memory 23 reads the packets stored in the storage area in the buffer memory 23 indicated by a reproduction pointer and outputs the read packets to the decoding accelerator 24 and the decoder 25 via the bus 29d.

For example, the program may be downloaded from a predetermined server on the network 10 or recorded on a recording medium such as a CD-ROM and read via a drive of the recording medium.

Finally, schematic configuration and schematic operation of the connection destination introducing server 3 of the embodiment will be described with reference to FIG. 11.

As shown in FIG. 11, the connection destination introducing server 3 of the embodiment has a controller 35 as connection destination introduction information transmitting means and generating means, a storage 36 as storing means, and a communication unit 37 as update information transmitting means. The components are connected to each other via a bus 38.

The controller 35 is constructed by a CPU having the computing function, a work RAM, a ROM for storing various data and programs (including an OS and various applications), and the like. The storage 36 is made by an HDD or the like for storing various data and the like. The communication unit 37 controls a communication of information with a node 2 or the like via the network 10.

In the configuration, a database is accumulated/stored in the storage 36. The database stores location information of the broadcasting station 1 and the nodes 2 participating in the distribution system S and topology information between the broadcasting station 1 and the nodes 2 and among the nodes 2 in the distribution system S. In addition, the reception quality statistical information transmitted from each of nodes 2 belonging to the distribution system S at that time point is accumulated/stored on the node 2 unit basis in the storage 36.

Concretely, the reception quality statistical information is, for example, an average packet rate of past one minute calculated on the basis of the amount of packets received by the nodes 2 (in the case where the quality parameter MP is used as the lower limit value of the packet rate) or an average packet loss ratio (in the case where the quality parameter MP is used as the upper limit value of the packet loss ratio). When the average packet rate or the average packet loss ratio as the reception quality statistical information deteriorates, it can be regarded that the content distribution state to the node 2 deteriorates (see the triangle mark in FIGS. 6 and 8).

The controller 35 controls the connection destination introducing server 3 generally by making the CPU included in the controller 35 execute a program stored in the storage 36 or the like. The controller 35 executes the processes of the embodiment while using the stored reception quality statistical information. In addition, when the upstream node introduction request message MG1 is transmitted from a node 2 which is not participating, for example, the node N illustrated in FIG. 2, the controller 35 performs the above-described authorizing process (such as a process of determining validity of a digital certificate attached to a participation request) as a normal process. When the digital certificate is valid, the location information of the node N and a digest of the digital certificate, for example, a hash value obtained by hashing the digital certification with a predetermined hash function is stored in the database.

When the authentication is valid, the controller 35 sends the upstream node candidate message MG2/MG10 to the node N which has sent the upstream node introduction request message MG1 via the communication unit 37. The message MG2/MG10 includes the location information and hierarchical level information of a plurality of upstream nodes 2 as connection destination candidates (information indicating the hierarchical level of each of the upstream nodes 2). In the node N which receives the upstream node candidate message MG2/MG10, network proximities in the distribution system S of the plurality of upstream nodes 2 as connection destination candidates are compared with each other. The upstream node 2 existing in the position closest to the node N is selected. By transmission/reception of the connection request message MG3 and the connection permission response message MG4 to/from the upstream node 2, a connection is established. The location information of the upstream node 2 whose connection is established is sent (returned) to the connection destination introducing server 3. In contrast, the controller 35 stores the topology information of the node N into the database.

Next, the processes of the embodiment in the node 2, the broadcasting station 1, and the connection destination introducing server 3 having the above-described configuration will be concretely described with reference to FIGS. 12 to 17.

### (I) Processes in Node

First, processes in the node 2 in the distribution system S will be described with reference to FIGS. 12 to 14. Each of the nodes 2 in the first embodiment executes the same processes as those of FIGS. 12 to 14.

With reference to FIG. 12, the participation process (steps S1 to S10 (in FIG. 2)) executed in each of the nodes 2 of the embodiment to the received packet relaying process and reproducing process (steps S11 to S15) will be described.

As shown in FIG. 12, when a power switch is turned on to turn on a main power source and an auxiliary power source in any of nodes 2 in the first embodiment (hereinbelow, a node 2 whose processes will be described with reference to FIGS. 12 to 14 will be called a target node 2), first, the program stored in the target node 2 and the components are initialized by the controller 21 (step S1). The auxiliary power source is kept on until the power supply to the target node 2 is completely interrupted after turn-off of the main power source.

After completion of the initialization, the controller 21 of the target node 2 checks to see whether or not an operation of making the target node 2 participate in the distribution system S (that is, an operation of requiring reception of content data of the selected channel) is performed (step S2). The checking process is executed in such a manner that the controller 21 of the target node 2 determines whether or not an operation of selecting a channel corresponding to the broadcasting station 1 the user desires to watch is executed by the user of the controller 21.

When the operation is executed (YES in step S2), the controller 21 transmits the upstream node introduction request message MG1 for actual participation in the distribution system S to the connection destination introducing server 3 (step S3).

After that, the controller 21 checks whether the power supply switch in the target node 2 is turned off or not (step S4). When the power supply switch is not turned off (NO in step S4), the controller 21 returns to the step S2 and repeats the above-described series of processes. On the other hand, when it is determined in step S4 that the power supply switch is turned off (YES in step S4), the controller 21 turns off the main power source, executes the process of withdrawing from the distribution system S in which the target node 2 has been participated until then, after that, also turns off the auxiliary power source (step S5), and finishes the processes of the target node 2.

On the other hand, when it is determined in step S2 for the first time that the participation operation is not performed or it is determined in the step S2 for the second time or later that the upstream node introduction request message MG1 has been transmitted to the connection destination introducing server 3 (NO in step S3), the controller 21 checks to see whether or not the upstream node candidate message MG2/MG10 as a response to the upstream node introduction request message MG1 is received from the connection destination introducing server 3 or not (step S6).

When the upstream node candidate message MG2/MG10 is received (YES in step S6), the controller 21 selects another node 2 to be connected from the upstream node candidate message MG2/MG10, and executes a so-called NAT (Network Address Translation) process on the selected node 2 (step S7).

The NAT process is executed to pass packets over gateways which are set on the network segment unit basis in order to transmit/receive packets among different network segments.

After completion of the NAT process, the controller 21 sends the connection request message MG3 to the node 2 as the target of the NAT process to receive distribution of an actual packet (step S8).

After transmission of the upstream node introduction request message MG3, the controller 21 transmits a not-shown data transmission start request message to a connection destination on the upstream side in order to actually receive content data distributed (step S9). To the data transmission start request message, for example, an MAC (Media Access Control) address of a gateway in a LAN (Local Area Network), information of a cipher communication method used when the target node 2 receives a packet, and the like are attached as security information. After that, the controller 21 sends a message notifying of participation in the topology of the distribution system S to the connection destination introduction server 3 (step S10). After that, the controller 21 shifts to the process in the step S4 and repeats the series of processes.

On the other hand, when it is determined in the step S6 that the participation process and the process of connection to an upstream node have been completed (NO in step S6), the controller 21 checks to see whether or not a new packet has been received from another node 2 on the upstream side after the participation (step S1).

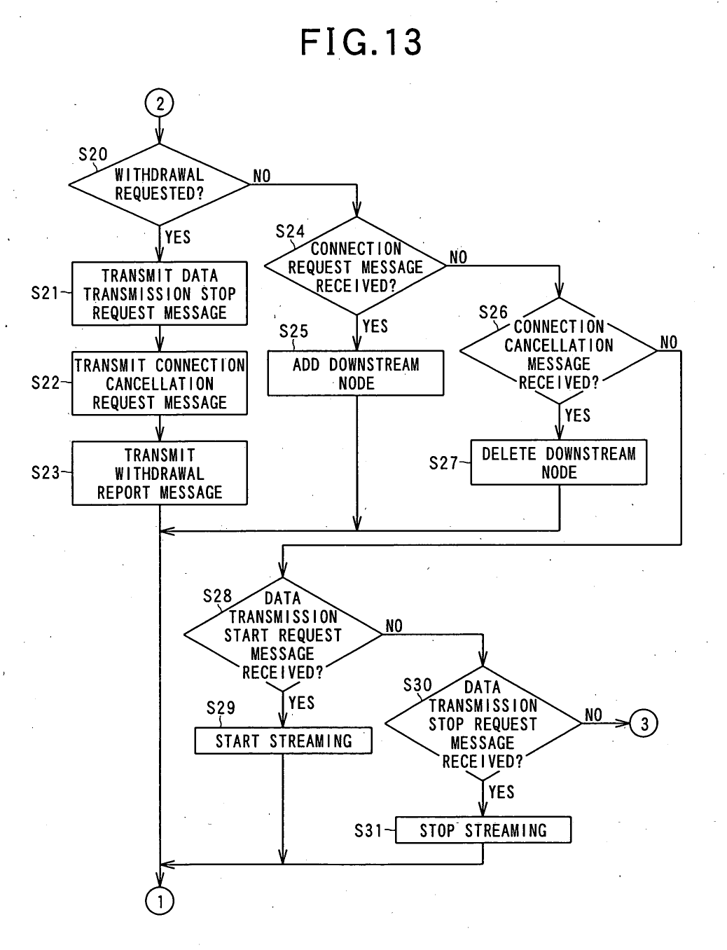

In the case where no packet is received from the node 2 on the upstream side (NO in step S11), the controller 21 moves to the process shown in FIG. 13 which will be described later. On the other hand, in the case where a packet is received (YES in step S11), the reception quality statistical information managed in the storage 22 and the controller 21 is updated on the basis of the reception mode of the packet (step S12).

Next, the controller 21 checks whether another node 2 connected on the downstream side of the target node 2 exists or not (step S13). In the case where the node 2 on the downstream side exists (YES in step S13), while relaying necessary packets to the node 2 on the downstream side (step S14), the controller 21 outputs the received packet to its decoder 25, and reproduces the decoded content by using the video processor 26 and the sound processor 28 (step S15). After that, the controller 21 moves to the process in the step S4 and repeats the above-described series of processes. In the case where it is determined in the step S13 that the node 2 on the downstream side does not exist (NO in step S13), the controller 21 shifts to the step S15 and executes the reproducing process in itself.

Next, processes after the process in the step S11 in which no packet is received from the node 2 on the upstream side (NO in step S11) will be described with reference to FIG. 13. Referring to FIG. 13, the withdrawal process executed in the target node 2 in the embodiment (steps S20 to S23), the participation process and the withdrawal process of another node 2 which is newly participating on the downstream side of the target node 2 (steps S24 to S27), and processes from the start to the end of distribution of content data in the embodiment (steps S28 to S31) will be described.

When it is determined in the step S11 shown in FIG. 12 that no packet is received (NO in step S1), as shown in FIG. 13, the controller 21 checks to see whether an operation of withdrawing from the distribution system S is performed or not in the target node 2 in a packet reception waiting state (step S20).

When the withdrawal process is performed during the monitoring process in step S20 (YES in step S20), the controller 21 transmits the data transmission stop request message MG5 and the connection cancellation request message MG6 to the immediately upstream node 2 connected at the time point (steps S21 and S22, see FIG. 3). The controller 21 sends a not-shown withdrawal report message indicative of withdrawal from the topology of the distribution system S to the connection destination introducing server 3 (in step S23), shifts to the process in the step S4 shown in FIG. 12, and repeats the series of processes.

On the other hand, when it is determined in step S20 that the withdrawal operation is not performed (NO in step S20), the controller 21 checks to see whether or not a new connection request message MG3 or connection cancellation request message MG6 is transmitted from another node 2 connected on the downstream side during monitoring of the operation (steps S24 and S26).

When the connection request message MG3 is transmitted (YES in step S24), the controller 21 executes the process of connection to another node 2 on the downstream side by adding (registering) the location information of the another node 2 on the downstream side into node management information stored in the storage 22 in correspondence with the connection request message MG3 (step S25), shifts to the process in the step S4 shown in FIG. 12, and repeats the series of processes.

On the other hand, when it is determined in steps S24 and S26 that no new connection request message MG3 is not received (NO in step S24) but a new connection cancellation request message MG6 is received (YES in step S26), the controller 21 executes the process of deleting another node 2 on the downstream side by deleting the location information of another node 2 on the downstream side from the node management information in correspondence with the connection cancellation request message MG6 (step S27), shifts to the process in the step S4 shown in FIG. 12, and repeats the series of processes.

Further, when it is determined in step S26 that a new connection cancellation request message MG6 is not also received (NO in step S26), the controller 21 checks to see whether the data transmission start request message is received from another node 2 connected on the downstream side or not (step S28).

When the data transmission start request message is received (YES in step S28), in response to the data transmission start request message, the controller 21 transmits a packet as normal content data to another node 2 on the downstream side (step S29). The controller 21 shifts to the process in step S4 shown in FIG. 12 and repeats the series of processes.

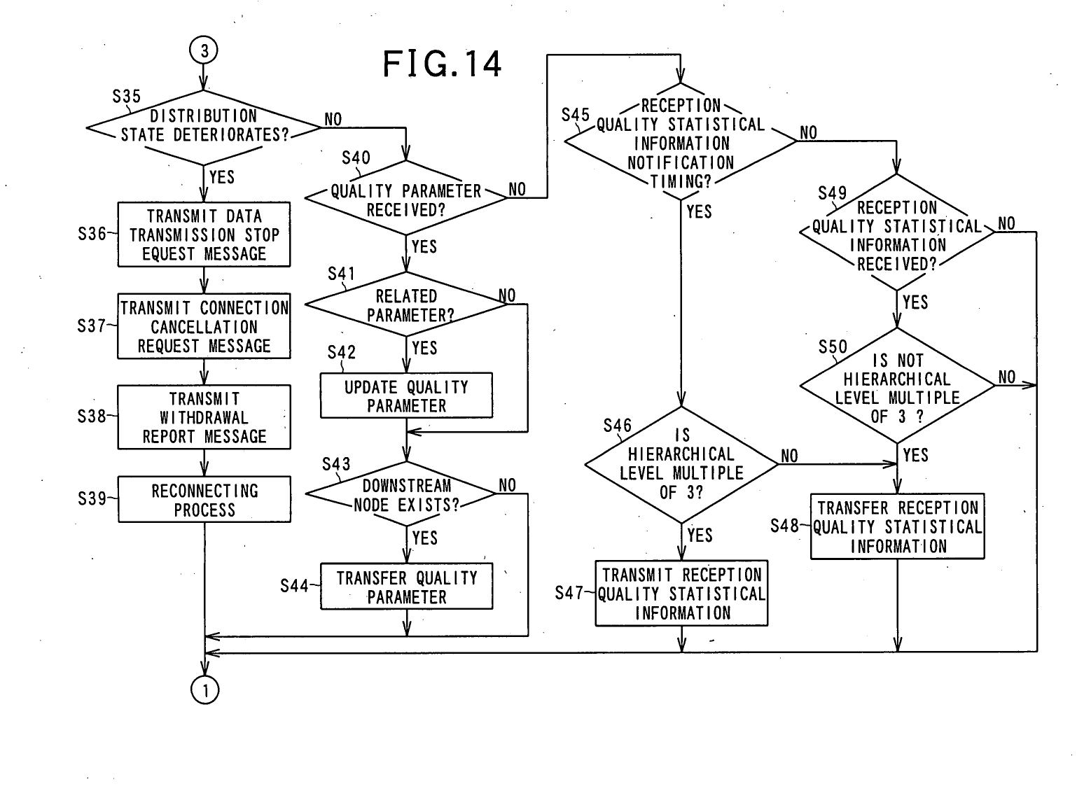

On the other hand, when it is determined in step S28 that the data transmission start request message is not received (NO in step S28), the controller 21 checks to see whether or not the data transmission stop request message MG5 is received from another node 2 on the downstream side (step S30). When the data transmission stop request message MG5 is not also received (NO in step S30), the controller 21 shifts to the process shown in FIG. 14 which will be described later. On the other hand, when the data transmission stop request message MG5 is received (YES in step S30), the controller 21 stops transmission of packets as content data to another node 2 on the downstream side (step S31), shifts to the process in step S4 shown in FIG. 12, and repeats the series of processes.

Processes performed after it is determined in the step S30 that the data transmission stop request message MG5 is not also received (NO in step S30) will be described with reference to FIG. 14.

When it is determined in step S30 shown in FIG. 13 that the data transmission stop request message MG5 is not also received (NO in step S30), the controller 21 checks to see whether or not the distribution state of content from the node 2 on the upstream side has deteriorated in the target node 2 (step S35). The determining method in the step S35 is carried out by, concretely, checking whether the amount of actual distribution to the target node 2 becomes lower than that shown in the quality parameter MP stored in the storage 22 of the target node 2 at the time point or not. That is, when the quality parameter MP is the lower limit value of the packet rate, the controller 21 determines whether the actual distribution amount becomes lower than the lower limit value or not (in the case where the actuation distribution amount is lower than the lower limit value, the distribution state deteriorates). On the other hand, when the quality parameter MP is the upper limit value of the packet loss ratio, the controller 21 determines whether the actual distribution amount exceeds the upper limit value or not (in the case where the actual distribution amount exceeds the upper limit value, the distribution state deteriorates).

When it is determined in the step S35 that the distribution state deteriorates (that is the actual distribution amount becomes smaller than the distribution amount indicated by the quality parameter MP) (YES in step S35), the controller 21 starts the reconnecting process from that time point. More concretely, the controller 21 sends the data transmission stop request message MG5 and the connection cancellation request message MG6 to a node 2 on the immediately upstream side connected at the time point (steps S36 and S37, see FIG. 3). The controller 21 transmits a not-shown withdrawal report message indicative of withdrawal from the topology of the distribution system S to the connection destination introducing server 3 (step S38) and, then, executes the reconnecting process shown in FIG. 4 (step S39). After that, the controller 21 shifts to the process in the step S4 shown in FIG. 12 and repeats the series of processes.

On the other hand, when it is determined in step S35 that the distribution state has not deteriorate (NO in step S35), the controller 21 checks whether the quality parameter MP (MP1 or MP2) has been received from the upstream node 2 or not (step S40, see FIGS. 5 to 8). When any of the quality parameters MP is received (YES in step S40), the controller 21 checks whether or not the quality parameter MP is addressed to the target node 2 including itself on the basis of the node ID included in the quality parameter MP (step S41).

In the case where it is determined in the step S41 that the quality parameter MP is addressed to the node 2 including the controller 21 itself (YES in step S41), the controller 21 updates the quality parameter MP stored in the storage 22 to a quality parameter MP newly received (step S40) (step S42). On the other hand, in the case where it is determined in the step s41 that the quality parameter MP is not addressed to the node 2 including the controller 21 itself (NO in step S41), the controller 21 shifts to the process in step S43 which will be described below.

Next, the controller 21 determines whether another node 2 connected on the downstream side of the target node 2 exists or not (step S43). In the case where a node 2 on the downstream side exists (YES in step S43), the controller 21 transfers the new quality parameter MP received in the process of the step S40 to the node 2 on the downstream side (step S44). After that, the controller 21 moves to the process in the step S4 shown in FIG. 12 and repeats the series of processes. In the case where it is determined in the step S43 that a node 2 on the downstream side does not exist (NO in step S43), the controller 21 shifts to the process in the step S4 shown in FIG. 12 and repeats the series of processes.

On the other hand, when it is determined in the step S40 that the quality parameter MP is not received (NO in step S40), the controller 21 checks whether a preset transmission timing has arrived or not in order to transmit the reception quality statistical information managed (step S12 in FIG. 12) with the storage 22 by itself to the connection destination introducing server 3 (step S45). Whether the transmission timing which is preset like “every one minute” has arrived or not is monitored by counting time by the controller 21 itself.

When it is determined in the step S45 that the transmission timing has arrived (YES in step S45), the controller 21 determines whether or not the node 2 in which the controller 21 itself is included belongs to a hierarchical level indicated by, for example, a multiple of 3 as the hierarchical level in the distribution system S (step S46). As the determining method in the step S46, for example, an inquiry message for inquiring the connection destination introducing server 3 is transmitted.

When the hierarchical level to which the node 2 that includes the controller 21 belongs is the hierarchical level indicated by a multiple of 3 in the distribution system S (YES in step S46), the controller 21 transmits all of the reception quality information related to the controller 21 itself to the connection destination introduction server 3 (step S47). As the process in the step S47, concretely, the controller 21 transmits, by a predetermined method, both of the reception quality statistical information managed in the node 2 in which the controller 21 itself is included and the reception quality statistical information transmitted from a node 2 connected on the downstream side of the node 2 and belonging to a hierarchical level which is not a multiple of 3 in the distribution system S. After that, the controller 21 shifts to the process of the step S4 shown in FIG. 12 and repeats the series of processes.

The reason why all of the reception quality statistical information of the other nodes 2 is transmitted by the node 2 belonging to the hierarchical level indicated by a multiple of 3 in the processes in the steps S46 to S48 and the step S50 is to prevent occurrence of excessive processing in the connection destination introducing server 3 or the broadcasting station 1 caused by reception quality statistical information transmitted from all of the nodes 2.

When it is determined in the step S46 that the hierarchical level to which the node 2 including the controller 21 is not a hierarchical level indicated by a multiple of 3 in the distribution system S (NO in step S46), the controller 21 transmits reception quality statistical information managed in the node 2 to the node 2 on the upstream side (step S48). After that, the controller 21 shifts to the process in the step S4 shown in FIG. 12 and repeats the series of processes.

When it is determined in the step S45 that the transmission timing of the reception statistical information has not arrived yet (NO in step S45), the controller 21 checks to see whether the reception quality statistical information has transmitted from the node 2 connected on the downstream side or not (step S49). When the reception quality statistical information has been transmitted (YES in step S49), the controller 21 checks to see whether or not the node 2 including the controller 21 itself does not belong to, for example, a hierarchical level indicated by a multiple of 3 as the hierarchical level in the distribution system 3 (step S50).

When the node 2 including the controller 21 itself does not belong to a hierarchical level indicated by a multiple of 3 (YES in step S50), the controller 21 transmits the reception quality statistical information from another node 2 received in the step S49 to the node 2 on the upstream side (step S48). After that, the controller 21 shifts to the process in the step S4 shown in FIG. 12 and repeats the series of processes.

On the other hand, when it is determined in the step S49 that the reception quality statistical information has not been also transmitted (NO in step S49) or when it is determined in the step S50 that the node 2 including the controller 21 itself belongs to a hierarchical level indicated by a multiple of 3 (NO in step S50), the controller 21 shifts to the process in the step S4 shown in FIG. 12 and repeats the series of processes.

### (II) Processes of Broadcasting Station

Processes in the broadcasting station 1 of the embodiment will be concretely described with reference to FIG. 15.

In the broadcasting station 1 of the embodiment, as shown in FIG. 15, when the power supply switch of the broadcasting station 1 is turned on, first, the controller 11 initializes each of the programs and the components stored in the broadcasting station 1 so that content can be transmitted to the nodes 2 and a message and the like can be received from the connection destination introduction server 3 (step S51).

After completion of the initialization, the controller 11 checks to see whether or not an operation of starting or stopping distribution of content in the distribution system S is executed in the input unit 16 of the broadcasting station 1 or not by the administrator of the distribution system S (that is, the broadcasting station 1) (step S52). When it is determined that the operation is performed (YES in step S52), the controller 11 starts or stops distribution of packets of corresponding content into the distribution system S on the basis of the operation (step S53).

After that, the controller 11 checks whether the power supply switch in the broadcasting station 1 is turned off or not (step S54). When the power supply switch is not turned off (NO in step S54), the controller 11 returns to the step S52 and repeats the series of processes. On the other hand, when it is determined in the step S54 that the power supply switch is turned off (YES in step S54), the controller 11 turns off the main power supply switch of the broadcasting station 1 and finishes the processes of the broadcasting station 1.

On the other hand, when it is not determined in the step S52 that the operation of starting or stopping distribution of content is performed (NO in step S52), the controller 11 checks to see whether or not the connection request message MG3 or the connection cancellation request message MG6 is received from any of the nodes 2 (step S54′).

When it is determined that either the connection request message MG3 or the connection cancellation request message MG6 is transmitted (YES in step S54′), in the case where the connection request message MG3 is transmitted, the controller 11 executes the process of connection to another node 2 on the downstream side by adding (registering) the location information of another node 2 on the downstream side to the node management information stored in the storage 12 in correspondence with the connection request message MG3 (step S55). On the other hand, in the case where the connection cancellation request message MG6 is received, the controller 11 executes the process of deleting another node 2 on the downstream side by deleting the location information of the another node 2 on the downstream side from the node management information in the storage 11 in correspondence with the connection cancellation request message MG6 (step S55). After that, the controller 11 shifts to the process in the step S54 and repeats the process.

On the other hand, when it is determined in the step S54′ that neither the connection request message MG3 nor the connection cancellation request message MG6 has not been received (NO in step S54′), the controller 11 checks whether the data transmission start request message or the data transmission stop request message MG5 is received from another node 2 connected on the downstream side or not (step S56).

When the data transmission start request message or the data transmission stop request message MG5 is received (YES in step S56), in the case where the data transmission start request message is received, the controller 11 transmits packets of normal content data to another node 2 on the downstream side in response to the data transmission start request message (step S57). On the other hand, when the data transmission stop request message MG5 is received, the controller 11 stops transmission of packets of content data to another node 2 on the downstream side (step S57). After that, the controller 11 shifts to the process of the step S54 and repeats the process.

Finally, when it is determined in the step S56 that neither the data transmission start request message nor the data transmission stop request message MG5 is received (NO in step S56), the controller 11 checks to see whether a new quality parameter MP (MP1 or MP2) is received from the connection destination introducing server 3 or not (step S58).

When the quality parameter MP is received (YES in step S58), the controller 1 checks whether a node 2 is connected on the downstream side of the broadcasting station 1 or not (step S59). When the node 2 is connected (YES in step S59), the controller 11 transmits the quality parameter MP newly transmitted from the connection destination introducing server 3 to the node 2 (step S60). After that, the controller 11 shifts to the process in the step S54 and repeats the process.

On the other hand, when a new quality parameter MP is not received in the check of the step S58 (NO in step S58) or when the node 2 is not connected in the check of the step S59 (NO in step S60), the controller 11 shifts to the process in the step S54 and repeats the process.

### (III) Processes of Connection Destination Introducing Server

Finally, processes performed in the connection destination introducing server 3 of the embodiment will be concretely described with reference to FIGS. 16 and 17.

In FIG. 16, a normal connection introducing process and the like executed in the connection destination introduction server 3 will be described (steps S61 to S65 (see FIG. 2)). With reference to FIG. 17, the quality parameter control process in the embodiment executed in the connection destination introducing server 3 will be described.

As shown in FIG. 16, when the power supply switch of the connection destination introducing server 3 in the embodiment is turned on, the controller 35 initializes each of the programs and the components stored in the connection destination introducing server 3 so that a message can be received from the nodes 2 and the broadcasting station 1 (step S61).

After completion of the initialization, the controller 35 checks to see whether a registration request message from a new broadcasting station 1 or a deletion request message from an existing broadcasting station 1 in the distribution system S has been received or not (step S62). When one of the messages is received (YES in step S62), in the case of registering a new broadcasting station 1, the controller 35 registers the location information of the broadcasting station 1 into the database and registers information of a new channel and the like into the database of the topology. In the case of deleting the existing broadcasting station 1, the controller 35 deletes the location information or the like of the broadcasting station 1 from the database and, further, deletes the corresponding channel information from the database of the topology (steps S63 and S64).

After that, the controller 35 determines whether the service of the connection destination introducing server 3 is stopped or not (step S65). In the case of stopping the service in the check of the step S65 (YES in step S65), the controller 35 turns off the power supply of the connection destination introducing server 3 and finishes the process.

On the other hand, when it is determined in the step S65 that the service is continued (NO in step S65), the controller 35 returns to the step S62 and repeats the series of processes.

On the other hand, when it is determined in the step S62 that neither the registration request message from the broadcasting station 1 nor the deletion request message is received (NO in step S62), the controller 35 determines whether the upstream node introduction request message MG1 is received from a node 2 newly participating in the distribution system S or not (step S66).

When the upstream node introduction request message MG1 is received (YES in step S66), the controller 35 retrieves a candidate of a node 2 (for example, the node 2b in the case of FIG. 2) capable of connecting anode 2 which has sent the upstream node introduction request message MG1 to the downstream side from the stored database of the topology (step S67). After that, the controller 35 sends the location information or the like of the node 2 corresponding to the retrieved candidate as the upstream node candidate message MG2/MG10 to the node 2 as the requester (step S68), and shifts to the process in the step S65.

On the other hand, when it is determined in step S66 that the upstream node introduction request message MG1 is not also received (NO in step S66), the controller 35 checks to see whether or not the participation report message (see step S10 in FIG. 12) or the withdrawal report message (see step S23 in FIG. 13) is received from any of the nodes 2 (step S69).

When the participation report message or the withdrawal report message is received (YES in step S69), the controller 35 determines that there is a change in the topology on the basis of the received report message, updates the database of the topology on the basis of the message (step S70), and shifts to the process in the step S65.

Finally, when it is determined in the step S69 that neither the participation report message nor the withdrawal report message is received (NO in step S69), the controller 35 determines whether the reception quality statistical information is received from the node 2 presently belonging to the distribution system S or not as shown in FIG. 17 (step S71). The reception quality statistical information is periodically transmitted together with reception quality statistical information corresponding to a node 2 belonging to another hierarchical level from a node belonging to a hierarchical level shown by a multiple of 3 (steps S46 and S50 in FIG. 14). In the case where the reception quality statistical information is transmitted (YES in step S71), the controller 35 updates the reception quality statistical information on the node 2 stored in the storage 36 by using the transmitted information (step S72). After that, the controller 35 shifts to the process in the step S65.

On the other hand, when it is determined in the step S71 that the reception quality statistical information is not transmitted from any of the nodes 2 (NO in step S71), the controller 35 determines, for example, whether a periodical quality state monitoring timing which is preset has arrived or not on the basis of counting of a not-shown timer or the like provided for the controller 35 itself (step S73).

The quality state monitoring timing is preset as a timing of determining whether the content distribution state (reception quality) in each of nodes 2 presently belonging to the distribution system S deteriorates or not (see the triangle mark in FIG. 6 or 8) on the basis of reception quality statistical information stored in the storage 36 in each of the nodes 2.

When it is determined in the step S73 that the quality state monitoring timing has arrived (YES in step S73), the controller 35 determines whether a node 2 for which the quality parameter MP has to be changed due to deterioration in the distribution state exists in the distribution system S or not (step S74). In step S74, on the basis of the number of nodes 2 whose distribution state deteriorates and the degree of the deterioration, the controller 35 determines that the quality parameter MP is controlled in the mode described with reference to FIG. 6 or in the mode described with reference to FIG. 8.

When it is determined that the node 2 for which the quality parameter MP has to be controlled does not exists in the distribution systems (NO in step S74), the controller 35 directly shifts to the process in the step S65. On the other hand, when it is determined that a node 2 for which the quality parameter MP has to be controlled exists (YES in step S74), the controller 35 calculates the value of the changed quality parameter MP on the basis of the data at the time of the determination, and transmits the value together with the node ID of a node 2 as the destination of the quality parameter MP to the broadcasting station 1 (step S75).

In the case of controlling the quality parameter MP in the mode of FIG. 6, the controller 35 sets, for example, R_{L}=60 packets/second in the quality parameter MP1 for the nodes 2g, 2h, 2p, 2q, 2r, and 2s and transmits the resultant quality parameter MP1 to the nodes 2.

In the case of controlling the quality parameter MP in the mode shown in FIG. 8, the controller 35 transmits the quality parameter MP1 which is, for example, R_{L}=60 packets/second, for the nodes 2g, 2h, 2p, 2p, 2r, and 2s and the nodes 2n, 2o, 2ab, 2ac, 2d, and 2ae to each of the nodes. The controller 35 transmits the quality parameter MP2 which is, for example, R_{L}=80 packets/second, for the nodes 2a, 2b, 2d, 2e, 2i, 2j, 2k, 2m, 2t, 2u, 2v, 2w, 2x, 2y, 2z, and 2aa to the nodes 2.

The controller 35 starts not-shown another timer in the controller 35 to store information into the storage 36 for predetermined time using, as an event, occurrence of necessity to control the quality parameter MP as the distribution state deteriorates (YES in step S74) (step S76). Concurrently, the controller 35 stores the value of the quality parameter MP sent in the step S75 and the transmission time as a transmission record together with identification information into a nonvolatile area in the storage 36. After that, the controller 35 shifts to the process in the step S65.

When it is determined in the step S73 that the quality state monitoring timing has not arrived, the controller 35 determines whether counting in the another timer started in the step S76 has arrived at preset time using a period in which the quality parameter MP is changed (step S77). When the counting has not arrived at the preset time (NO in step S77), the controller 35 shifts to the process in the step S65 while continuing counting in another timer.

On the other hand, when it is determined in the step S77 that the time has elapsed (YES in step S77), to reset the quality parameter MP changed by the process in the step S75 to the original standard value, the controller 35 transmits the quality parameter MP corresponding to the standard value to the node 2 as the destination of the quality parameter MP in the step S75 via the broadcasting station 1 (step S78). In this case, the standard value is the quality parameter MP corresponding to the stationary state (refer to FIG. 5). The controller 35 executes the process in the step S78 with reference to the transmission record stored in the storage 36 in association with the process in the step S75. After that, the controller 35 shifts to the process in the step S65.

As described above, in the operations of the distribution system S of the embodiment, the content distribution state is detected in each of the nodes 2. While continuing the distribution, when the state becomes worse than the value expressed by the quality parameter MP, a node 2 reconnects its upper node 2 to a new node 2 indicated by the connection distribution introducing server 3. Consequently, as compared with the conventional manner of performing reconnection for the first time when distribution of content is completely stopped, deterioration in the distribution state can be detect meticulously.

Therefore, at the stage that the distribution state in each of the nodes 2 deteriorates, the influence can be minimized and the reliability of the distribution system S can be improved.

Since the quality parameter MP as a criterion of reconnection is transmitted from the connection destination introducing server 3, the criterion of deterioration in the distribution state can be uniformly used in each of the nodes 2 to which a destination is introduced from the connection destination introducing server 3.

Further, since the controller 35 sets the lower limit value of a packet rate or the upper limit value of the packet loss ratio as the quality parameter MP, deterioration in the distribution state in each of nodes 2 is easily detected and reconnection can be performed.

Further, the controller 35 stores reception quality statistical information from each of the nodes 2 into the connection destination introducing server 3, generates the upstream node candidate message MG10 corresponding to the upstream node introduction request message MG9 from each of the nodes 2 on the basis of the stored reception quality statistical information, and transmits the upstream node candidate message MG10 to the node 2. By controlling occurrence of reconnection in each of the nodes 2 in the connection destination introducing server 3 using the distribution state information of each of the nodes 2, distribution of the entire distribution system S can be stabilized.

The controller 35 generates a new quality parameter MP for updating the quality parameter MP corresponding to each of the nodes 2 on the basis of the reception quality statistical information corresponding to each of the nodes 2 and requests for reconnection to address deterioration in the distribution state on the basis of the new quality parameter MP and the distribution state at the time point in each of the nodes 2. Consequently, by controlling occurrence of reconnection in each of the nodes 2 in the connection destination introducing server 3 via the quality parameter MP to each of the nodes 2, distribution of the entire distribution system S can be stabilized.

Further, the controller 35 generates a new quality parameter MP so that reconnection in the node 2 included in a part of a hierarchical tree having, at the apex, the node 2 whose distribution state deteriorates is suppressed more than that in another node 2. Therefore, chain-reaction of reconnection in nodes 2 included in the part of the hierarchical tree lower than the node 2 at the apex can be suppressed in response to deterioration in the distribution state in the node 2 at the apex. Thus, the entire distribution system S can be prevented from becoming unstable.

When the number of nodes 2 in which the distribution state deteriorates is equal to or larger than a preset threshold (for example, 2) (refer to FIG. 8), the controller 35 generates the new quality parameter MP2 so that occurrence of reconnection in the nodes 2 out of the hierarchical tree having, as the apex, the node 2 in which the distribution sate deteriorates is suppressed more than that before the distribution state deteriorates. Therefore, in the node 2 in which occurrence of reconnection is suppressed, the functions of a node 2 connected in place of the node 2 in which the distribution state deteriorates are assured more easily. As a result, stabilization when the number of deteriorations in the distribution state in the entire distribution system S is large can be further promoted.

In the foregoing embodiment, division of the time zone in a day is not considered, and the processes shown in FIGS. 12 to 17 are executed uniformly. Alternately, 24 hours of one day may be divided into preset time divisions, and the controller 35 controls the quality parameter MP on the division unit basis.

Generally, there are similar tendencies in the use distribution of networks such as the Internet irrespective of the kinds of lines. For example, it is generally known that the communication traffic in the Internet between 9 p.m. to 12 p.m. is the maximum. In the time zone, the influence on the distribution quality in the distribution system S is the maximum.

Therefore, in consideration of the above, the connection destination introducing server 3 uses the divided time zone of one day as a determination element of the quality parameter MP in addition to the fluctuation state of the topology (the degree of deterioration in the distribution state).

Concretely, for example, in the time zone in which the communication traffic is the maximum, the controller 35 generates a new quality parameter MP by multiplying the quality parameter MP with a tolerance coefficient α in which the time zone is considered. In the case illustrated in FIGS. 5 to 8, with respect to the time zone, the controller 35 generates a new quality parameter MP by decreasing the packet rate lower limit value by 20 percent from the standard value or increasing the packet loss ratio by 20 percent from the standard value.

With the configuration, the controller 35 generates a new quality parameter MP on the basis of the reception quality statistical information and the preset time divisions in one day, so that the distribution state can be finely controlled every time division.

In the foregoing embodiment, the quality parameter MP is determined on the basis of the momentarily fluctuation state in the topology. It is also possible to reflect changes in the past distribution state at the time of determining a new quality parameter MP.

In the foregoing embodiment, for example, when the topology becomes unstable as shown in FIG. 6, the sensitivity of the quality parameter MP becomes lower as a whole. The controller 35 controls so that even if the topology changes to a steady state shown in FIG. 5 in short time immediately after that, the sensitivity of the quality parameter MP is not immediately recovered to the original standard value.

The content distribution immediately after reconnection is accelerated as compared with that in the stationary state and, generally, packet loss tends to occur. Consequently, the controller 35 waits for predetermined time until the state of the content distribution becomes stable and, then, resets the quality parameter MP to the standard value, thereby suppressing the topology from becoming unstable again.

Concretely, at the time of changing (resetting) the quality parameter MP from the present value (for example, the quality parameter MP1) to the standard value, the controller 35 controls so that the change is made in predetermined time or longer.

With the configuration, the controller 35 generates a new quality parameter MP after lapse of preset time so that the entire distribution system S can be prevented from becoming unstable due to frequent changes in short time of the new quality parameter MP.

Further, in the foregoing embodiment, to suppress occurrence of reconnection in the nodes 2, the method of changing the quality parameter MP is employed. Except for the method, when the upstream node introduction request message MG9 is transmitted from a node 2 in which the distribution state deteriorates is transmitted to the connection destination introducing server 3, also by delaying the timing of sending back the upstream node candidate message MG10 as a response in the connection destination introducing server 3, occurrence of reconnection in the node 2 as a result can be suppressed (in time). In this case, a control of shortening or extending the delay time in accordance with the number of nodes 2 in which the distribution state deteriorates is executed.

In the configuration, the reception quality statistical information indicative of the distribution state in each of the nodes 2 is stored in the connection destination introducing server 3. On the basis of the stored reception quality statistical information, the controller 35 controls the timing of transmitting the upstream node candidate message MG10. By controlling the occurrence timing of the reconnection in each of the nodes 2 in the connection destination introducing server 3 using the reception quality statistical information of each of the nodes 2, distribution in the entire distribution system S can be stabilized.

By recording a program corresponding to the flowcharts shown in FIGS. 12 to 14 in an information recording medium such as a flexible disk or hard disk, or by obtaining such a program via the Internet or the like and recording it, and reading and executing the program by a general computer, the computer can be also utilized as the controller 21 in the node 2 in the embodiment.

Further, by recording a program corresponding to the flowchart shown in FIG. 15 on an information recording medium such as a flexible disk or a hard disk, or obtaining the program via the Internet and recording it, and reading and executing the program by a general computer, the computer can be utilized as the controller 11 in the broadcasting station 1 of the embodiment.

Further, by recording a program corresponding to the flowchart shown in FIGS. 16 and 17 onto an information recording medium such as a flexible disk or a hard disk, or obtaining the program via the Internet or the like and recording it, and reading and executing the program by a general computer, the computer can be utilized as the controller 35 in the connection destination introducing server 3 of the embodiment.

As described above, the present invention can be used in the field of content distribution using the distribution system having the tree structure. Particularly, when the invention is applied to the field of content distribution in which interruption of the distribution is inconvenient like real-time broadcasting of a movie, music, and the like, conspicuous effects are obtained.

The present invention is not confined to the configuration listed in the foregoing embodiments, but it is easily understood that the person skilled in the art can modify such configurations into various other modes, within the scope of the present invention described in the claims.

1. An information processor included in a network system in which a plurality of information processors are connected in a hierarchical tree shape via a network, and distribution information is distributed to any of the information processors along the hierarchical tree, comprising:
distribution state detecting means for detecting a state of distribution of the distribution information;
storing means for storing reference information indicative of a criterion to determine whether the state deteriorates or not;
request information transmitting means, when the distribution is continued and the state becomes worse than the criterion, for transmitting request information that requests for transmission of connection destination information indicative of a new information processor to be connected in the network system, to a connection destination introducing apparatus included in the network system and transmitting the connection destination information; and
reconnecting means for establishing a new connection for the distribution to another information processor indicated by the connection destination information transmitted from the connection destination introducing apparatus in response to the transmitted request information.

2. The information processor according to claim 1,
wherein the reference information is transmitted from the connection destination introducing apparatus, and
when it is found that the state deteriorates on the basis of the detected distribution state and the transmitted reference information, the request information transmitting means transmits the request information to the connection destination introducing apparatus.

3. The information processor according to claim 1,
wherein the distribution state detecting means detects reception speed of the received distribution information, and
when the detected reception speed becomes equal to or less than a lower limit value indicated by reception speed lower-limit-value information as the reference information, the request information transmitting means transmits the request information to the connection destination introducing apparatus.

4. The information processor according to claim 1,
wherein the distribution state detecting means detects a loss ratio of the distribution information received, and
when the detected loss ratio becomes equal to or higher than an upper limit value indicated by loss ratio upper-limit-value information as the reference information, the requested information transmitting means transmits the request information to the connection destination introducing apparatus.

5. A connection destination introducing apparatus included in a network system in which a plurality of information processors according to claim 1 are connected in a hierarchical tree shape, and for transmitting connection destination information to an information processor to be reconnected, comprising:
storing means for storing the distribution state information transmitted from the information processor; and
connection destination information transmitting means, when the request information sent from the information processor is received, for generating the connection destination information on the basis of the stored distribution state information, and transmitting the connection destination information to the information processor which has sent the request information.

6. The connection destination introducing apparatus according to claim 5,
wherein each of the information processors further comprises updating means, when updated reference information (calculated based upon distribution status) is transmitted from the connection destination introducing apparatus, for storing the transmitted updated reference information as new reference information into the storage, and
the connection destination introducing apparatus comprises:
generating means for newly generating the updated reference information on the basis of the stored distribution state information; and
update information transmitting means for transmitting the generated updated reference information to each of the information processors.

7. The connection destination introducing apparatus according to claim 6,
wherein the generating means generates the updated reference information on the basis of the stored distribution state information so that occurrence of the reconnection in the information processors included in a part of the hierarchical tree having, as an apex, the information processor in which the distribution state deteriorates is suppressed more than that of the reconnection in the information processor included in another part of the hierarchical tree.

8. The connection destination introducing apparatus according to claim 6,
wherein when the number of the information processors in which the distribution state deteriorates is larger than a preset threshold, the generating means generates the update reference information so that occurrence of the reconnection in the information processors included in a part of the hierarchical tree other than the part of the hierarchical tree having, as an apex, the information processor in which the distribution state deteriorates is suppressed more than before the distribution state deteriorated.

9. The connection destination introducing apparatus according to claim 6,
wherein the generating means generates the update reference information on the basis of the stored distribution state information and a preset time division.

10. The connection destination introducing apparatus according to claim 6,
wherein the generating means generates the updated reference information only after lapse of preset time from an immediately preceding timing of generating the updated reference information.

11. The connection destination introducing apparatus according to claim 5,
wherein the reference information and the updated reference information is reception speed lower-limit-value information indicative of a lower limit value of reception speed of the distribution information received by the information processor, and
when the detected reception speed becomes equal to or lower than the lower limit value indicated by the reception speed lower-limit-value information, the request information transmitting means provided for each of the information processors transmits the request information.

12. The connection destination introducing apparatus according to claim 5,
wherein the reference information and the updated reference information is loss ratio upper-limit-value information indicative of an upper limit value of a loss ratio of the distribution information received by the information processor and
when the detected loss ratio becomes equal to or higher than the upper limit value indicated by the loss ratio upper-limit-value information, the request information transmitting means provided for each of the information processors transmits the request information.

13. The connection destination introducing apparatus according to claim 5,
wherein the connection destination information transmitting means controls a timing of transmitting the connection destination information corresponding to the request information transmitted from the information processor on the basis of the stored distribution state information.

14. A network system in which a plurality of information processors are connected in a hierarchical tree shape via a network, and distribution information is distributed to any of the information processors along the hierarchical tree, and
including a connection destination introducing apparatus for transmitting connection destination information indicative of a new connection destination to the information processor for performing reconnection in each of the information processors,
wherein each of the information processors comprises:
distribution state detecting means for detecting a state of distribution of the distribution information in each of the information processors;
storing means for storing reference information as a criterion to determine whether the state has deteriorated or not;
request information transmitting means, when the distribution is continued and the state becomes worse than the criterion, for transmitting request information that requests for transmission of connection destination information indicative of a new connection destination of the information processor in the network system, to a connection destination introducing apparatus included in the network system and transmitting the connection destination information; and
reconnecting means for establishing a new connection for the distribution to another information processor indicated by the connection destination information transmitted from the connection destination introducing apparatus in response to the transmitted request information, and
the connection destination introducing apparatus comprises:
storing means for storing the distribution state information transmitted from the information processor; and
connection destination information transmitting means, when the request information transmitted from the information processor is received, for generating the connection destination information on the basis of the stored distribution state information, and transmitting the connection destination information to the information processor which has sent the request information.

15. An information processing method executed by an information processor included in a network system in which a plurality of information processors are connected in a hierarchical tree shape via a network and distribution information is distributed to any of the information processors along the hierarchical tree, comprising:
a distribution state detecting step for detecting a state of distribution of the distribution information;
a request information transmitting step, when the distribution is continued and the state becomes worse than the criterion, for transmitting request information that requests for transmission of connection destination information indicative of a new connection destination of the information processor in the network system, to a connection destination introducing apparatus included in the network system and transmitting the connection destination information; and
a reconnecting step for establishing a new connection to the distribution to another information processor indicated by the connection destination information sent from the connection destination introducing apparatus in response to the transmitted request information.

16. An information processing method executed by a connection destination introducing apparatus included in a network system in which a plurality of information processors according to claim 1 are connected in a hierarchical tree shape, and for transmitting connection destination information to an information processor to be reconnected, comprising:
a storing step for storing the distribution state information transmitted from the information processor into storing means; and
a connection destination information transmitting step, when the request information transmitted from the information processor is received, for generating the connection destination information on the basis of the stored distribution state information, and transmitting the connection destination information to the information processor which has transmitted the request information.

17. A recording medium on which a program for an information processor for making a computer function as the information processor in claim 1 is recorded in such a manner that it can be read by the computer.

18. A recording medium on which a program for a connection destination introducing apparatus for making a computer function as the connection destination introducing apparatus in claim 5 is recorded in such a manner that it can be read by the computer.
